(19) United States
(12) Patent Application Publication
(10) Pub. No.: US 2019/0095273 A1
(43) Pub. Date: Mar. 28, 2019

(54) PARITY BITS LOCATION ON I3C MULTILANE BUS

(71) Applicant: QUALCOMM Incorporated, San Diego, CA (US)

(72) Inventors: Sharon GRAIF, Zichron Yaakov (IL); Amit GIL, Zichron Yaakov (IL); David TEB, Haifa (IL); Radu PITIGOI-ARON, San Jose, CA (US)

(21) Appl. No.: 16/123,737

(22) Filed: Sep. 6, 2018

Related U.S. Application Data
(60) Provisional application No. 62/564,159, filed on Sep. 27, 2017.
(60) Provisional application No. 62/594,960, filed on Dec. 5, 2017.

(51) Int. Cl. G06F 11/10; G06F 1/04; G06F 11/07; G06F 13/42

(52) U.S. Cl. CPC G06F 11/10; G06F 13/4291; G06F 11/0793; G06F 1/04

(57) ABSTRACT

Systems, methods, and apparatus are described that enable a serial bus to be operated in one or more modes that employ additional wires for communicating data. An apparatus has a bus including a first lane and a second lane, a plurality of devices coupled to the bus and, in a first mode of operation, the plurality of devices is configured to exchange data in a signal transmitted on the first lane in accordance with timing provided by a clock signal transmitted on the second lane. The apparatus may include one or more additional lanes connecting two or more devices in the plurality of devices, the two or more devices being configured to use the first lane and at least one of the additional lanes for data transmissions in a second mode of operation.

This application claims priority to and the benefit of U.S. Provisional Patent Application Ser. No. 62/564,159 filed in the U.S. Patent Office on Sep. 27, 2017 and U.S. Provisional Patent Application Ser. No. 62/594,960 filed in the U.S. Patent Office on Dec. 5, 2017, the entire content of these applications being incorporated herein by reference as if fully set forth below in its entirety and for all applicable purposes.

### BACKGROUND

### Technical Field

The present disclosure relates generally to an interface between processing circuits and peripheral devices and, more particularly, to expanding data communication throughput on a serial bus.

### Background

Mobile communication devices may include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol.

In one example, the Inter-Integrated Circuit serial bus, which may also be referred to as the I2C bus or the I²C bus, is a serial single-ended computer bus that was intended for use in connecting low-speed peripherals to a processor. In some examples, a serial bus may employ a multi-master protocol in which one or more devices can serve as a master and a slave for different messages transmitted on the serial bus. Data can be serialized and transmitted using two wires, of which one or both may be operated bidirectionally. A first wire may be designated as the Serial Data Line (SDA) that carries a data signal, and a second wire may be designated as the Serial Clock Line (SCL) that carries a clock signal.

In another example, a bus may be operated in accordance with the I3C protocol defined by the Mobile Industry Processor Interface Alliance (MIPI). The I3C protocol derives certain implementation aspects from the I2C protocol but support increased data signaling rates. Original I2C implementations supported data signaling rates up to 100 kilobits per second (100 kbps) in standard-mode, with more recent standards supporting speeds of 400 kbps in fast-mode, and 1 megabit per second (Mbps) in fast-mode plus.

As applications have become more complex, demand for throughput over the serial bus can escalate and capacity may be strained or exceeded.

### SUMMARY

Certain aspects of the disclosure relate to systems, apparatus, methods and techniques that support bus width expansion on a dynamic basis. Certain aspects relate to serial bus including an I3C bus that may be operated in a single data rate (SDR) mode of operation, double data rate (DDR) mode of operation, and/or a ternary encoding mode of operation.

In various aspects of the disclosure, an apparatus has a bus including a first lane and a second lane, a plurality of devices coupled to the bus and, in a first mode of operation, the plurality of devices is configured to exchange data in a signal transmitted on the first lane in accordance with timing provided by a clock signal transmitted on the second lane. The apparatus may include one or more additional lanes connecting two or more devices in the plurality of devices, the two or more devices being configured to use the first lane and at least one of the additional lanes for data transmissions in a second mode of operation.

In one example, a command transmitted in the first mode of operation defines the second mode of operation as a double data rate mode of operation. The command may define the number of additional lanes used for data transmissions used in the second mode of operation. Data may be encoded in symbols used to control signaling state of the first lane, the second lane and the one or more additional lanes in the second mode of operation, and the second command defines the number of bits in the symbols. In the second mode of operation, information corresponding to timing of symbol transmissions may be embedded in transitions between consecutively transmitted symbols.

In one example, a plurality of commands is transmitted on the bus, each command selecting a mode of operation for the bus and the number of additional lanes used for data transmissions in each selected mode of operation. Each command may be transmitted in the first mode of operation. Each of the two or more devices may be configured to support a number of data lanes. The two or more devices may be preconfigured by a master device to operate in both the first mode of operation and the second mode of operation. In the second mode of operation a master device is adapted to ascertain a number of available lanes coupled to each of the two or more devices, configure each slave device to use at least some of the available lanes in the second mode of operation, and dynamically adapt a protocol used in the second mode of operation to utilize a corresponding number of the available lanes when communicating with each slave device. The protocol may be used in the second mode of operation is adapted to use a varying number of lanes to encode symbols for transmission.

In some examples, data words are striped across lanes used to transmit data signals in the second mode of operation.

In certain examples, a first frame is transmitted in the first mode of operation using only the first lane and the second lane, and a second frame is transmitted in the second mode of operation using the first lane, the second lane and the at least one additional lane have a common frame duration. In one example, one or more parity bits transmitted in the first frame and a plurality of parity bits transmitted in the second frame are transmitted during the last of a plurality of clock cycles used to transmit the respective frames. In another example, one or more parity bits transmitted in the first frame and a plurality of parity bits transmitted in the second frame are transmitted during the first of a plurality of clock cycles used to transmit the respective frames.

In various aspects of the disclosure, a method includes configuring a plurality of devices coupled to a bus such that, in a first mode of operation, the plurality of devices exchange data in a signal transmitted on a first lane of the bus in accordance with timing provided by a clock signal transmitted on a second lane of the bus, determining availability of one or more additional lanes connecting two or more devices in the plurality of devices, and configuring the two or more devices to use the first lane and at least one of the additional lanes for data transmissions in a second mode of operation.

In various aspects of the disclosure, a processor-readable storage medium is disclosed. The storage medium may be a non-transitory storage medium and may store code that, when executed by one or more processors, causes the one or more processors to configure a plurality of devices coupled to a bus such that, in a first mode of operation, the plurality of devices exchange data in a signal transmitted on a first lane of the bus in accordance with timing provided by a clock signal transmitted on a second lane of the bus, determine availability of one or more additional lanes connecting two or more devices in the plurality of devices, and configure the two or more devices to use the first lane and at least one of the additional lanes for data transmissions in a second mode of operation.

In various aspects of the disclosure, a data communication apparatus includes means for configuring a plurality of devices coupled to a bus such that, in a first mode of operation, the plurality of devices exchange data in a signal transmitted on a first lane of the bus in accordance with timing provided by a clock signal transmitted on a second lane of the bus, means for determining availability of one or more additional lanes connecting two or more devices in the plurality of devices, and means for configuring the two or more devices to use the first lane and at least one of the additional lanes for data transmissions in a second mode of operation.

### BRIEF DESCRIPTION OF THE DRAWINGS

FIG. 1 illustrates an apparatus employing a data link between IC devices that is selectively operated according to one of plurality of available standards.

FIG. 2 illustrates a communication interface in which a plurality of devices is connected using a serial bus.

FIG. 3 illustrates certain aspects of an apparatus that includes multiple devices connected to a serial bus.

FIG. 4 includes a timing diagram that illustrates signaling on a serial bus when the serial bus is operated in a SDR mode of operation defined by I3C specifications.

FIG. 5 is a timing diagram that illustrates an example of a transmission in an I3C HDR mode, where data is transmitted at double data rate DDR.

FIG. 6 illustrates an example of signaling transmitted on the Data wire and Clock wire of a serial bus to initiate certain mode changes.

FIG. 7 illustrates certain aspects of a transmitter and a receiver according to certain aspects disclosed herein.

FIG. 8 illustrates the signaling state of a high data rate protocol (e.g., an I3C protocol) when transmitting symbols according to certain aspects disclosed herein.

FIG. 9 illustrates a first example of an encoding scheme for transcoding data according to certain aspects disclosed herein.

FIG. 10 illustrates a second example of an encoding scheme for transcoding data according to certain aspects disclosed herein.

FIG. 11 illustrates a serial bus in which more than two connectors or wires may be available for timeshared communication between devices.

FIG. 12 illustrates an example of encoding data in symbols across three or more conductors or wires.

FIG. 13 illustrates the transmission of data over an I3C serial bus operated in an SDR mode when two or more devices can be coupled to additional connectors, wires or lines.

FIG. 14 relates to an HDR-DDR mode of operation in which data is clocked on both edges of each clock pulse in the clock signal.

FIG. 15 is an example of a timeline illustrating the operation of a multi-lane enabled bus.

FIG. 16 illustrates datagram structures that may be received during a device read in accordance with certain aspects disclosed herein.

FIG. 17 illustrates first examples of datagram structures that may be transmitted during a device write where parity is transmitted with each byte of data in accordance with certain aspects disclosed herein.

FIG. 18 illustrates second examples of datagram structures that may be transmitted during a device write where parity is transmitted with each byte of data in accordance with certain aspects disclosed herein.

FIG. 19 is a block diagram illustrating an example of an apparatus employing a processing circuit that may be adapted according to certain aspects disclosed herein.

FIG. 20 is a flowchart illustrating a process that may be performed at a sending device coupled to a serial bus in accordance with certain aspects disclosed herein.

FIG. 21 illustrates a hardware implementation for a transmitting apparatus adapted to respond to support multi-lane operation of a serial bus in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a serial bus to connect an application processor or another host device with modems and other peripherals. The serial bus may be operated in accordance with specifications and protocols defined by a standards body. For example, the serial bus may be operated in accordance with a standard or protocol such as the I2C, I3C, serial low-power inter-chip media bus (SLIMbus), system management bus (SMB), radio frequency front-end (RFFE) protocols that define timing relationships between signals and transmissions. Certain aspects disclosed herein relate to systems, apparatus, methods and techniques that provide a mechanism that can be used on an I3C bus to dynamically extend the bus width and thereby improve bandwidth and/or throughput. When the bus width is extended, modified and/or improved error detection schemes may be employed to ensure link reliability.

For example, a method performed at a transmitting device coupled to a serial bus includes configuring a plurality of devices coupled to a bus such that, in a first mode of operation, the plurality of devices exchange data in a signal transmitted on a first lane of the bus in accordance with timing provided by a clock signal transmitted on a second lane of the bus. The transmitting device may determine availability of one or more additional lanes connecting two or more devices in the plurality of devices, and may configure the two or more devices to use the first lane and at least one of the additional lanes for data transmissions in a second mode of operation.

In certain examples, the transmitting device may send a command in the first mode of operation to define the second mode of operation as a double data rate mode of operation. The command may define a number of additional lanes used for data transmissions used in the second mode of operation.

Data may be encoded in symbols used to control signaling state of the first lane, the second lane and the one or more additional lanes in the second mode of operation, and a command transmitted in the first mode of operation defines a number of bits in the symbols. Information corresponding to timing of symbol transmissions is embedded in transitions between consecutively transmitted symbols in the second mode of operation.

The transmitting device may send a plurality of commands on the bus. Each command may be configured to select a mode of operation for the bus and a number of additional lanes used for data transmissions in each selected mode of operation. Each command is transmitted in the first mode of operation. One or more commands may be operative to configure each device in the two or more devices to support a number of data lanes. The transmitting device may ascertain a number of available lanes coupled to each of the two or more devices, configure each slave device to use at least some of the available lanes in the second mode of operation, and dynamically adapt a protocol used in the second mode of operation to utilize a corresponding number of the available lanes when communicating with each slave device. A protocol used in the second mode of operation may be adapted to use a varying number of lanes to encode symbols for transmission.

In some instances, data words are striped across lanes used to transmit data signals in the second mode of operation. A first frame may be transmitted in the first mode of operation using only the first lane and the second lane, and a second frame may be transmitted in the second mode of operation using the first lane, the second lane and the at least one additional lane. The first frame and the second frame may have a common frame duration. In one example, the transmitting device may provide first parity bits in the first frame, and may provide second parity bits in the second frame. The first parity bits and the second parity bits may be transmitted during the last of a plurality of clock cycles used to transmit the respective frames. In another example, the first parity bits may be transmitted in the first frame, and the second parity bits are transmitted in the second frame. The first parity bits and the second parity bits may be transmitted during the first of a plurality of clock cycles used to transmit the respective frames.

Example of an Apparatus with a Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

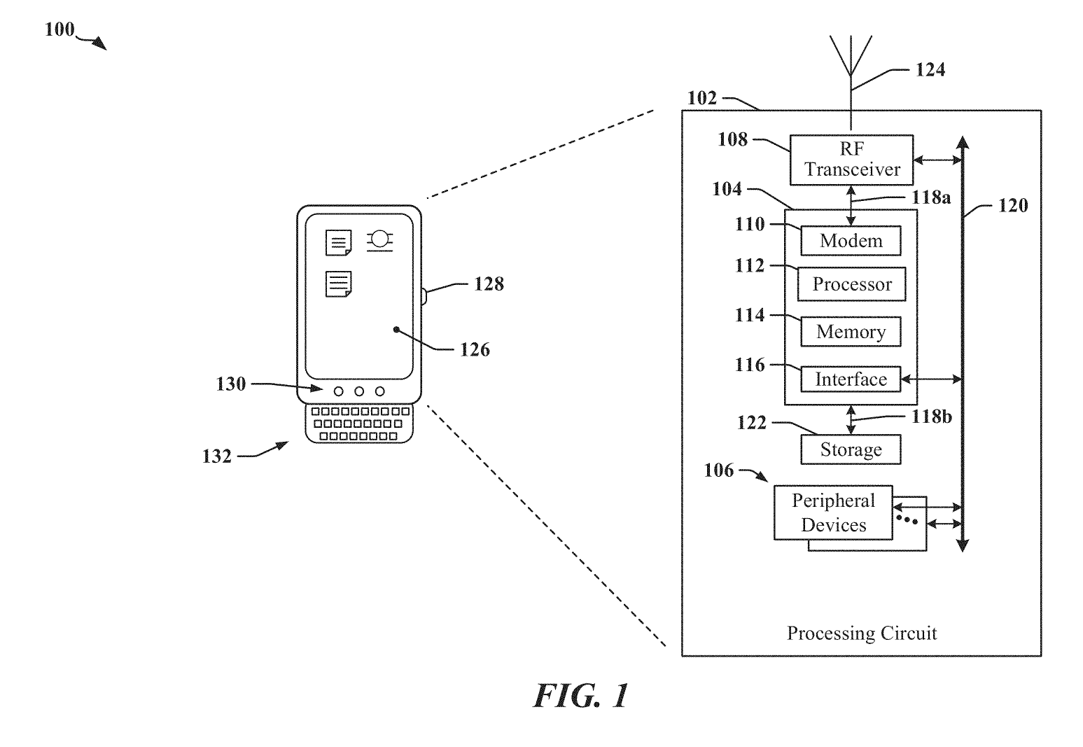

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may have a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

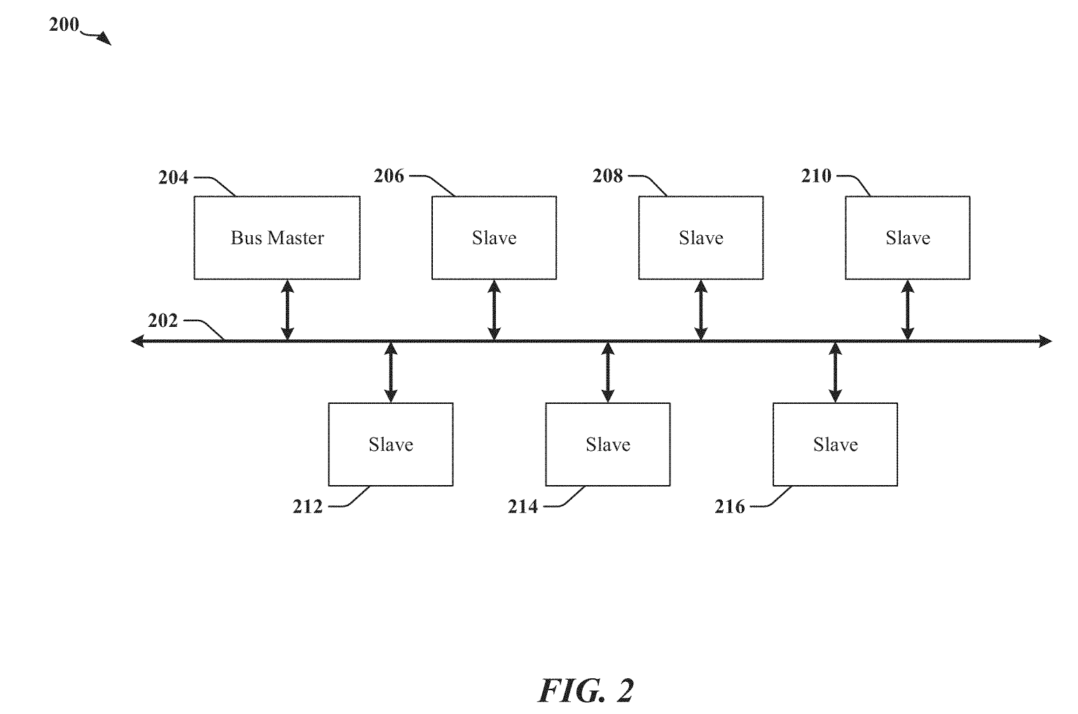

FIG. 2 illustrates a communication link 200 in which a configuration of devices 204, 206, 208, 210, 212, 214 and 216 are connected using a serial bus 202. In one example, the devices 204, 206, 208, 210, 212, 214 and 216 may be adapted or configured to communicate over the serial bus 202 in accordance with an I3C protocol. In some instances, one or more of the devices 204, 206, 208, 210, 212, 214 and 216 may alternatively or additionally communicate using other protocols, including an I2C protocol, for example.

Communication over the serial bus 202 may be controlled by a master device 204. In one mode of operation, the master device 204 may be configured to provide a clock signal that controls timing of a data signal. In another mode of operation, two or more of the devices 204, 206, 208, 210, 212, 214 and 216 may be configured to exchange data encoded in symbols, where timing information is embedded in the transmission of the symbols.

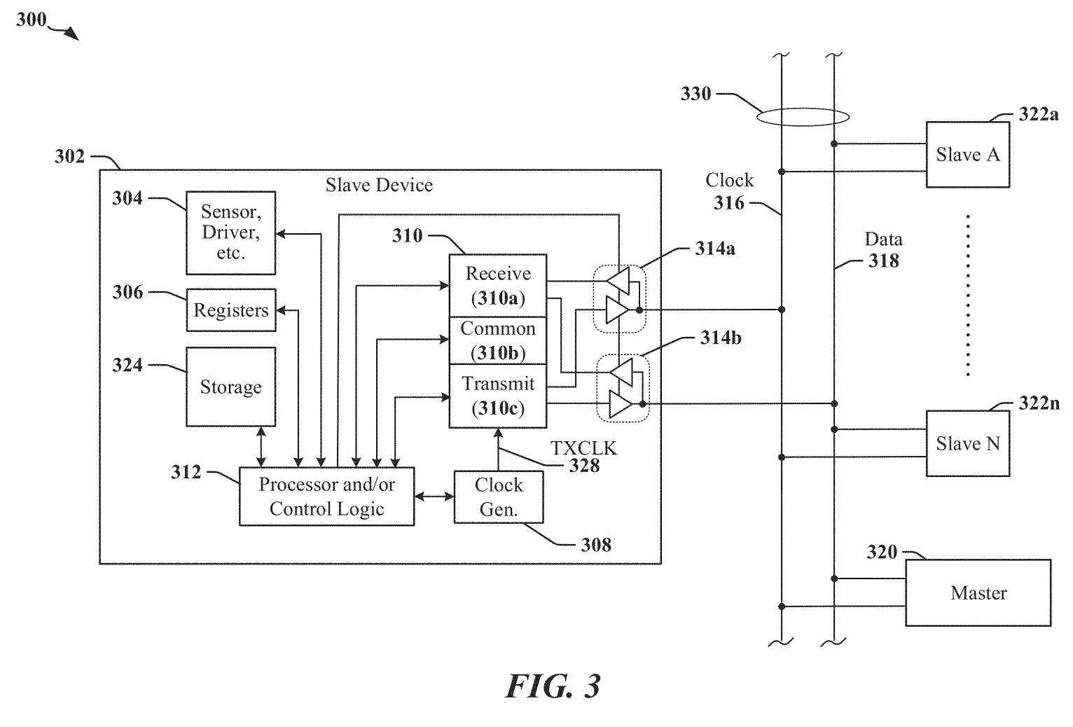

FIG. 3 illustrates certain aspects of an apparatus 300 that includes multiple devices 302, 320 and 322a-322n connected to a serial bus 330. The serial bus 330 may include a first wire 316 that carries a clock signal in certain modes of operation while a second wire 318 carries a data signal. In other modes of operation, data may be encoded in multi-bit symbols, where each bit of the symbol controls signaling state of one of the wires 316, 318. The devices 302, 320 and 322a-322n may include one or more semiconductor IC devices, such as an application processor, SoC or ASIC. Each of the devices 302, 320 and 322a-322n may include, support or operate as a modem, a signal processing device, a display driver, a camera, a user interface, a sensor, a sensor controller, a media player, a transceiver, and/or other such components or devices. Communications between devices 302, 320 and 322a-322n over the serial bus 330 is controlled by a bus master 320. Certain types of bus can support multiple bus masters 320.

The apparatus 300 may include multiple devices 302, 320 and 322a-322n that communicate when the serial bus 330 is operated in accordance with I2C, I3C or other protocols. At least one device 302, 322a-322n may be configured to operate as a slave device on the serial bus 330. In one example, a slave device 302 may be adapted to provide a sensor control function 304. The sensor control function 304 may include circuits and modules that support an image sensor, and/or circuits and modules that control and communicate with one or more sensors that measure environmental conditions. The slave device 302 may include configuration registers 306 or other storage 324, control logic 312, a transceiver 310 and line drivers/receivers 314a and 314b. The control logic 312 may include a processing circuit such as a state machine, sequencer, signal processor or general-purpose processor. The transceiver 310 may include a receiver 310a, a transmitter 310c and common circuits 310b, including timing, logic and storage circuits and/or devices. In one example, the transmitter 310c encodes and transmits data based on timing provided by a clock generation circuit 308.

Two or more of the devices 302, 320 and/or 322a-322n may be adapted according to certain aspects and features disclosed herein to support a plurality of different communication protocols over a common bus, which may include an SMBus protocol, an SPI protocol, an I2C protocol, and/or an I3C protocol. In some examples, devices that communicate using one protocol (e.g., an I2C protocol) can coexist on the same serial bus with devices that communicate using a second protocol (e.g., an I3C protocol). In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de facto I2C standards providing for data rates that may range between 100 kilobits per second (kbps) and 3.2 Mbps. I2C and I3C protocols may define electrical and timing aspects for signals transmitted on the 3-wire serial bus 330, in addition to data formats and aspects of bus control. In some aspects, the I2C and I3C protocols may define direct current (DC) characteristics affecting certain signal levels associated with the serial bus 330, and/or alternating current (AC) characteristics affecting certain timing aspects of signals transmitted on the serial bus 330.

### High-Speed Data Transfers Over an I3C Serial Bus

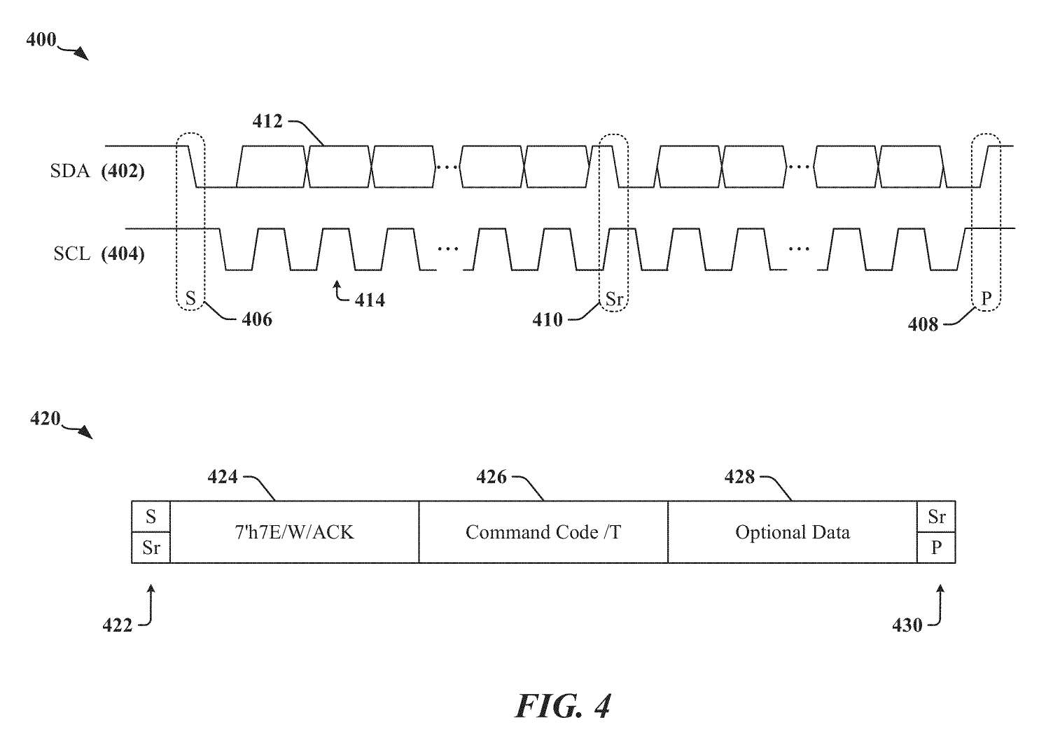

FIG. 4 includes a timing diagram 400 that illustrates signaling on a serial bus when the serial bus is operated in a single data rate (SDR) mode of operation defined by I3C specifications. Data transmitted on a first wire (the Data wire 402) of the serial bus may be captured using a clock signal transmitted on a second wire (the Clock wire 404) of the serial bus. During data transmission, the signaling state 412 of the Data wire 4 is expected to remain constant for the duration of the pulses 414 when the Clock wire 404 is at a high voltage level. Transitions on the Data wire 402 when the Clock wire 404 is at the high voltage level indicate a START condition 406, a STOP condition 408 or a repeated START 410.

On an I3C serial bus, a START condition 406 is defined to permit the current bus master to signal that data is to be transmitted. The START condition 406 occurs when the Data wire 402 transitions from high to low while the Clock wire 404 is high. The bus master may signal completion and/or termination of a transmission using a STOP condition 408. The STOP condition 408 is indicated when the Data wire 402 transitions from low to high while the Clock wire 404 is high. A repeated START 410 may be transmitted by a bus master that wishes to initiate a second transmission upon completion of a first transmission. The repeated START 410 is transmitted instead of, and has the significance of a STOP condition 408 followed immediately by a START condition 406. The repeated START 410 occurs when the Data wire 402 transitions from high to low while the Clock wire 404 is high.

The bus master may transmit an initiator 422 that may be a START condition 406 or a repeated START 410 prior to transmitting an address of a slave, a command, and/or data. FIG. 4 illustrates a command code transmission 420 by the bus master. The initiator 422 may be followed in transmission by a predefined command 424 indicating that a command code 426 is to follow. The command code 426 may, for example, cause the serial bus to transition to a desired mode of operation. In some instances, data 428 may be transmitted. The command code transmission 420 may be followed by a terminator 430 that may be a STOP condition 408 or a repeated START 410.

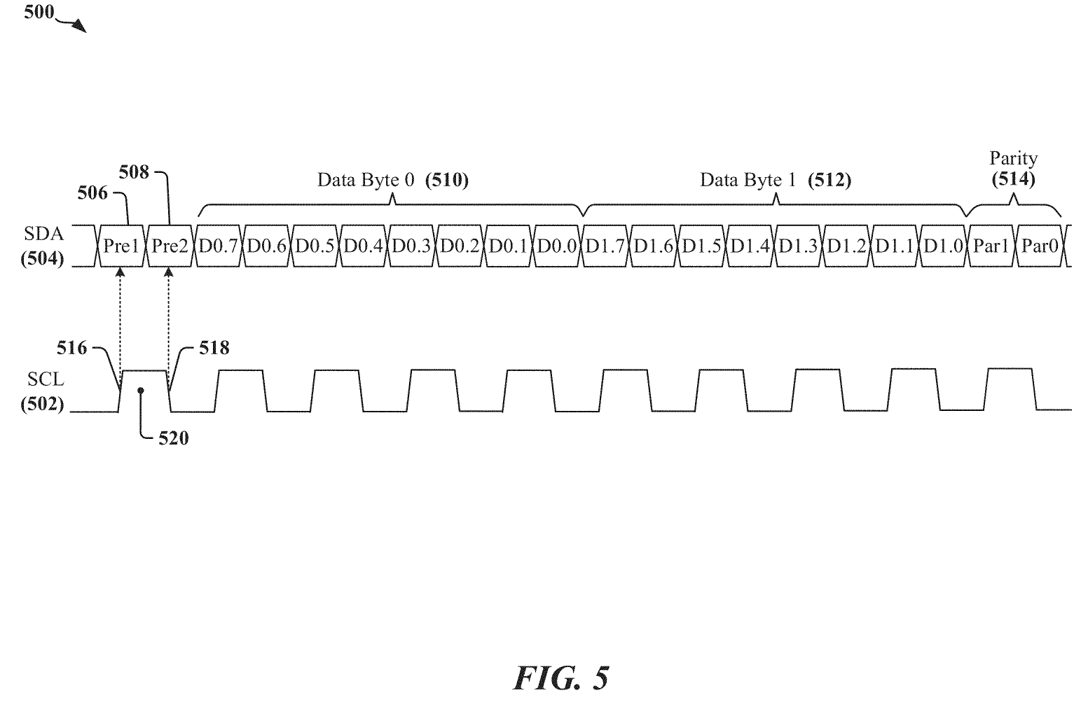

Certain serial bus interfaces support signaling schemes that provide higher data rates. In one example, I3C specifications define multiple high data rate (HDR) modes, including a high data rate, double data rate (HDR-DDR) mode in which data is transferred at both the rising edge and the falling edge of the clock signal. FIG. 5 is a timing diagram 500 that illustrates an example of a transmission in an I3C HDR-DDR mode, in which data transmitted on the Data wire 504 is synchronized to a clock signal transmitted on the Clock wire 502. The clock signal includes pulses 520 that are defined by a rising edge 516 and a falling edge. A master device transmits the clock signal on the Clock wire 502, regardless of the direction of flow of data over the serial bus. A transmitter outputs one bit of data at each edge 516, 518 of the clock signal. A receiver captures one bit of data based on the timing of each edge 516, 518 of the clock signal.

Certain other characteristics of an I3C HDR-DDR mode transmission are illustrated in the timing diagram 500 of FIG. 5. According to certain I3C specifications, data transferred in HDR-DDR mode is organized in words. A word generally includes 16 payload bits, organized as two 8-bit bytes 510, 512, preceded by two preamble bits 506, 508 and followed by two parity bits 514, for a total of 20 bits that are transferred on the edges of 10 clock pulses. The integrity of the transmission may be protected by the transmission of the parity bits 514.

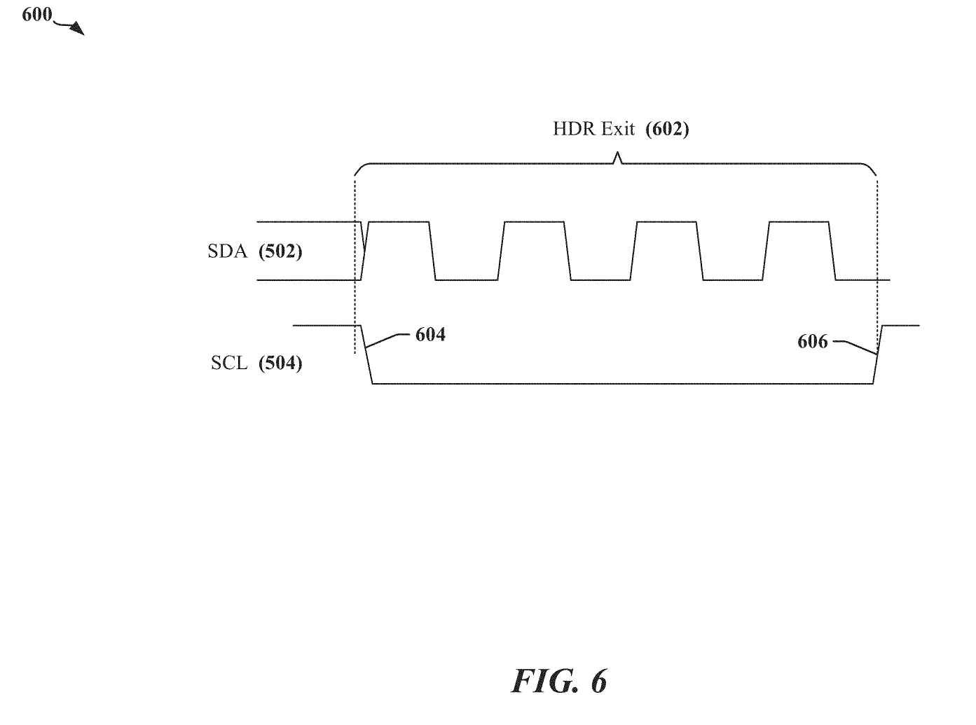

FIG. 6 illustrates an example of signaling 600 transmitted on the Data wire 504 and Clock wire 502 to initiate certain mode changes. The signaling 600 is defined by I3C protocols for use in initiating restart, exit and/or break from I3C HDR modes of communication. The signaling 600 includes an HDR Exit 602 that may be used to cause an HDR break or exit. The HDR Exit 602 commences with a falling edge 604 on the Clock wire 502 and ends with a rising edge 606 on the Clock wire 502. While the Clock wire 502 is in the low signaling state, four pulses are transmitted on the Data wire 504. I2C devices ignore the Data wire 504 when no pulses are provided on the Clock wire 502.

In another HDR mode, I3C specifications define a ternary encoding scheme in which transmission of a clock signal is suspended and data is encoded in symbols that define signals that are transmitted over the clock and data lines. Clock information is encoded by ensuring that a transition in signaling state occurs at each transition between two consecutive symbols.

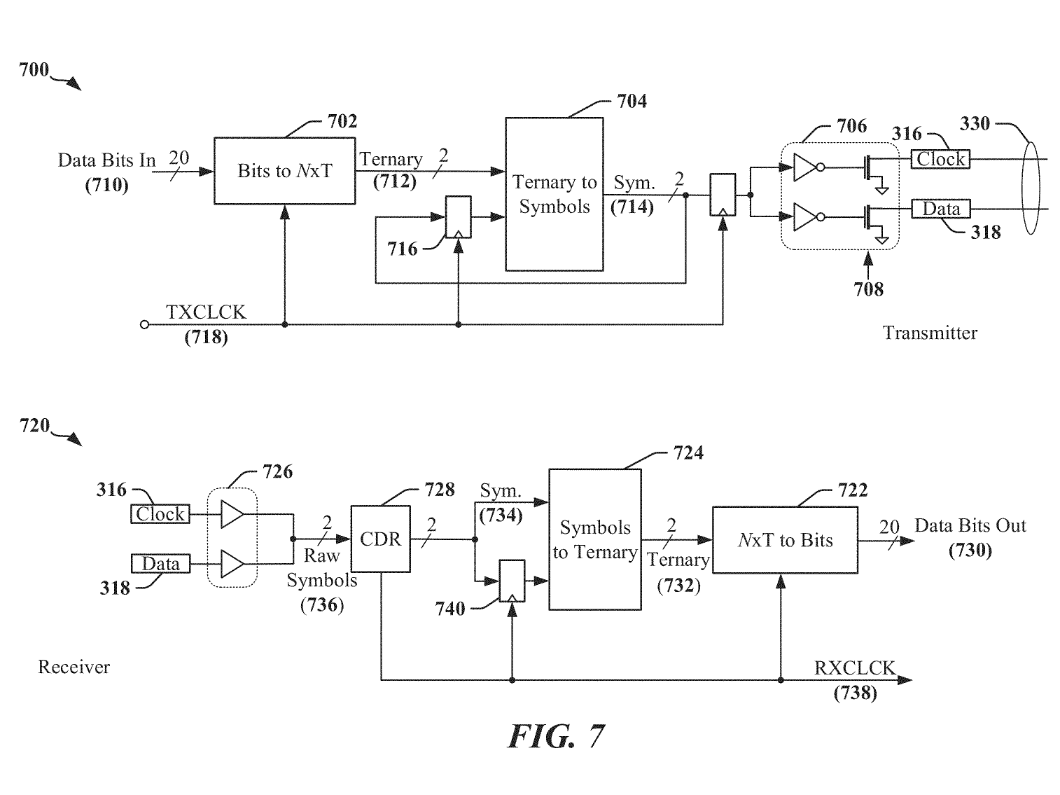

FIG. 7 is a block diagram illustrating an example of a transmitter 700 and a receiver 720 configured according to certain aspects disclosed herein. The example relates to a two-wire serial bus 330. For HDR ternary modes of operation, the transmitter 700 may transcode data 710 into ternary (base-3) numbers that are encoded as symbols transmitted on a pair of connectors, wires or line such as the Clock line 316 and Data line 318 signal wires. In the example depicted, each data element (also referred to as a data word) of the input data 710 may have a predefined number of bits, such as 8, 12, 16, 19 or 20 bits. A transcoder 702 may receive the input data 710 and produce a sequence of ternary numbers 712 for each data element. Each ternary number in the sequence of ternary numbers 712 may be encoded in two bits and there may be 12 ternary numbers in each sequence of ternary numbers 712. A ternary-to-symbols encoder 704 produces a stream of 2-bit symbols 714 that are transmitted through line drivers 706. In the example depicted, the line drivers 706 include open-drain output transistors 708. However, in other examples, the line drivers 706 may drive the Clock line 316 and Data line 318 signal wires using push-pull drivers. The output stream of 2-bit symbols 714 generated by the encoder has a transition in the state of at least one of the Clock line 316 and Data line 318 signal wires between consecutive symbols 714 by ensuring that no pair of consecutive symbols includes two identical symbols. The availability of a transition of state in at least one line 316 and/or 318 permits a receiver 720 to extract a receive clock 738 from the stream of symbols 714.

In a high data rate interface, the receiver 720 may include or cooperate with a clock and data recovery (CDR) circuit 728. The receiver 720 may include line interface circuits 726 that provide a stream of 2-bit raw symbols 736 to the CDR circuit 728. The CDR circuit 728 extracts a receive clock 738 from the raw symbols 736 and provides a stream of 2-bit symbols 734 and the receive clock 738 to other circuits 724 and 722 of the receiver 720. In some examples, the CDR circuit 728 may produce multiple clocks 738. A symbols-to-ternary decoder 724 may use the receive clock 738 to decode the stream of symbols 734 into sequences of 12 ternary numbers 732. The ternary numbers 732 may be encoded using two bits. A transcoder 722 may then convert each sequence of 12 ternary numbers 732 into 8, 12, 16, 19 or 20-bit output data elements 730.

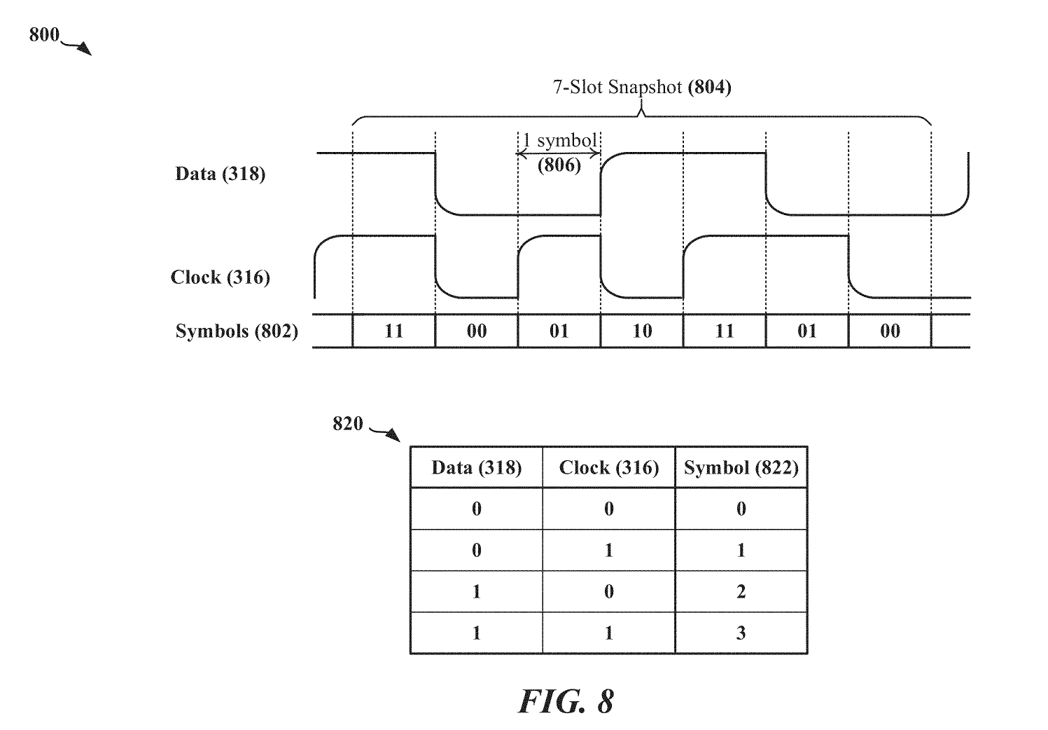

FIG. 8 includes a timing diagram 800 illustrating the signaling state of the shared serial bus 330 when transmitting a sequence of symbols according to certain aspects disclosed herein. In the example depicted, both the Data line 318 and the Clock line 316 are used to encode data. Raw symbol values 802 cause line driving circuits to drive each of the Data line 318 and Clock line 316 to voltage levels determined by one bit of the current raw symbol value 802. In the example, a symbol bit that is set to “binary 1” causes a corresponding one of the Data line 318 and Clock line 316 to a more positive voltage level, while a symbol bit that is set to “binary 0” causes a corresponding one of the Data line 318 and Clock line 316 to a more negative voltage level. FIG. 8 provides a table showing the four possible signaling states for symbols 822 when each of the Data line 318 and Clock line 316 can be at one of two voltage levels. A data element having K bits may be encoded in a sequence of L symbols. The values of K and L may be determined based on encoding scheme, word size and configuration and other application parameters, including latency, etc. The timing diagram 800 illustrates an extract or snapshot of a symbol transmission sequence that includes 7 slots 804, where a symbol 806 may be transmitted in each of the slots 804. The 7 slots illustrated may be part of a larger symbol sequence such as a 12-symbol sequence that encodes a 16-bit word, or may include two or more sequences of symbols (e.g., 2, 3 . . . or 6 symbol sequences).

According to certain aspects disclosed herein, a transmitter 700 may be configured or adapted to ensure that the same symbol is not transmitted in any two consecutive slots in a sequence of slots 804. Accordingly, at least one of the Data line 318 and Clock line 316 changes signaling state at each boundary between consecutive symbols. The toggling of either of the Data line 318 and the Clock line 316 marks the beginning of a new symbol.

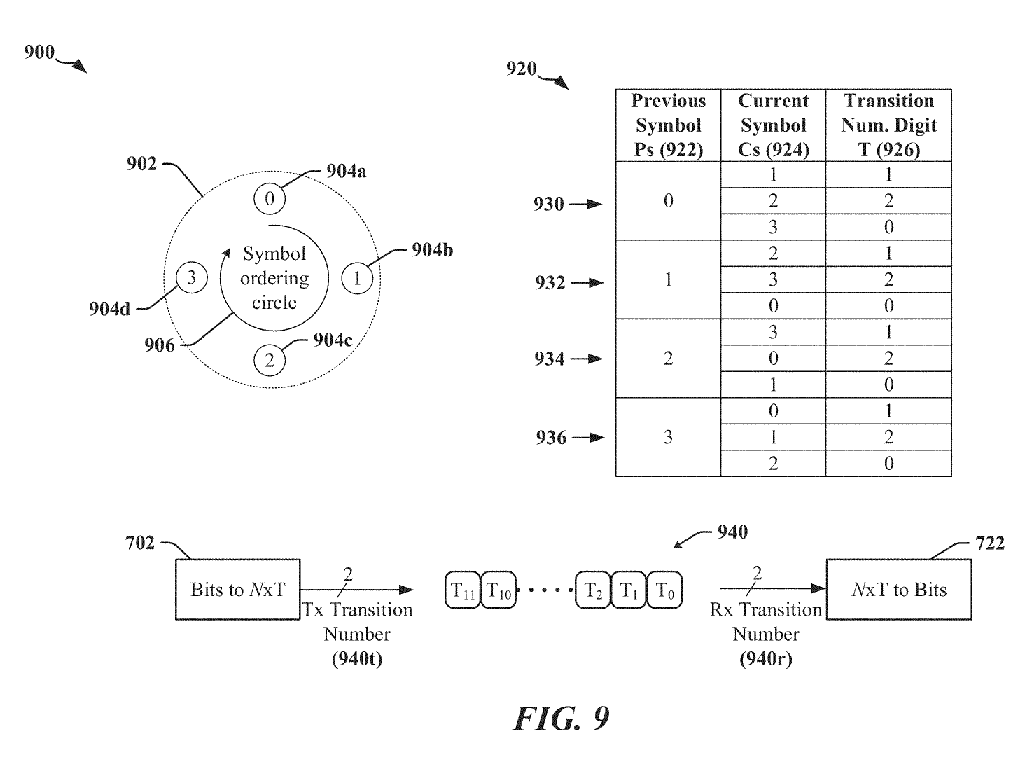

FIG. 9 is a drawing illustrating a first example of an encoding scheme 900 that may be used by the ternary-to-symbols encoder 704 to produce a sequence of symbols 714 with an embedded clock for transmission on the shared serial bus 330. The encoding scheme 900 may also be used by a symbols-to-ternary decoder 724 to extract ternary transition numbers from symbols received from the shared serial bus 330. In this encoding scheme 900, the two wires of the shared serial bus 330 permit definition of 4 basic symbols S: {0, 1, 2, 3}. Any two consecutive symbols in the sequence of symbols 714, 734 have different states, and the symbol sequences 0,0, 1,1, 2,2 and 3,3 are invalid combinations of consecutive symbols. Accordingly, only 3 valid symbol transitions are available at each symbol boundary, where the symbol boundary is determined by the transmit clock and represents the point at which a first symbol, (preceding symbol 922) terminates and a second symbol (current symbol 924) begins.

According to certain aspects disclosed herein, the three available transitions are assigned a transition number digit 926 (T) for each preceding symbol 922. The value of T can be represented by a ternary number. In one example, the value of a transition number digit 926 may be determined by assigning a symbol-ordering circle 902 for the encoding scheme. The symbol-ordering circle 902 allocates locations 904a-904d on the symbol-ordering circle 902 for the four possible symbols, and a direction of rotation 906 between the locations 904a-904d. In the depicted example, the direction of rotation 906 is clockwise. The transition number digit 926 may represent the separation between the valid current symbol 924 and the immediately preceding symbol 922. Separation may be defined as the number of steps along the direction of rotation 906 on the symbol-ordering circle 902 required to reach the current symbol 924 from the preceding symbol 922. The number of steps can be expressed as a single digit base-3 number. It will be appreciated that a three-step difference between symbols can be represented as a 0_{base-3}. The table 920 in FIG. 9 summarizes an encoding scheme employing this approach.

At the transmitter 700, the table 920 may be used to lookup a current symbol 924 to be transmitted, given knowledge of the previously-generated, preceding symbol 922 and an input ternary number, which is used as a transition number digit 926. At the receiver 720, the table 920 may be used as a lookup to determine a transition number digit 926 that represents the transition between the preceding symbol 922 and the current symbol 924.

According to certain aspects, a transition number 940 may be formed from a plurality of transition number digits 926, each transition number digit 926 being usable to determine a next symbol given a current symbol. In one example, the transition number 940 is a ternary number that includes 12 ternary transition number digits 926. In the general case, a transition number 940 having N transition number digits 926 with r possible transitions for each T has a total of r^{N} states. In the example of a 12-digit transition number 940, there are a total of r=4−1=3 possible transitions for each of the N=12 transition number digits 926, providing a total of 3¹²=531441 different states. Consequently, the 12-digit transition number 940 can encode 19-bit binary numbers which require 524288 states. The remaining 7153 states may be used to carry control codes, or the like.

A plurality of next-generation devices may coexist on the same shared bus with one or more legacy I2C devices. Accordingly, the high data rate protocol defines signaling schemes that can be ignored, undetected or otherwise disregarded by legacy I2C devices. The I3C devices may transmit control information in signaling that is consistent with I2C mode signaling, and may transmit the data payload encoded according to ternary coding-based protocols to obtain faster transmission speeds. The next-generation devices may use other encoding modes for transmitting the data payload, including legacy I2C modes.

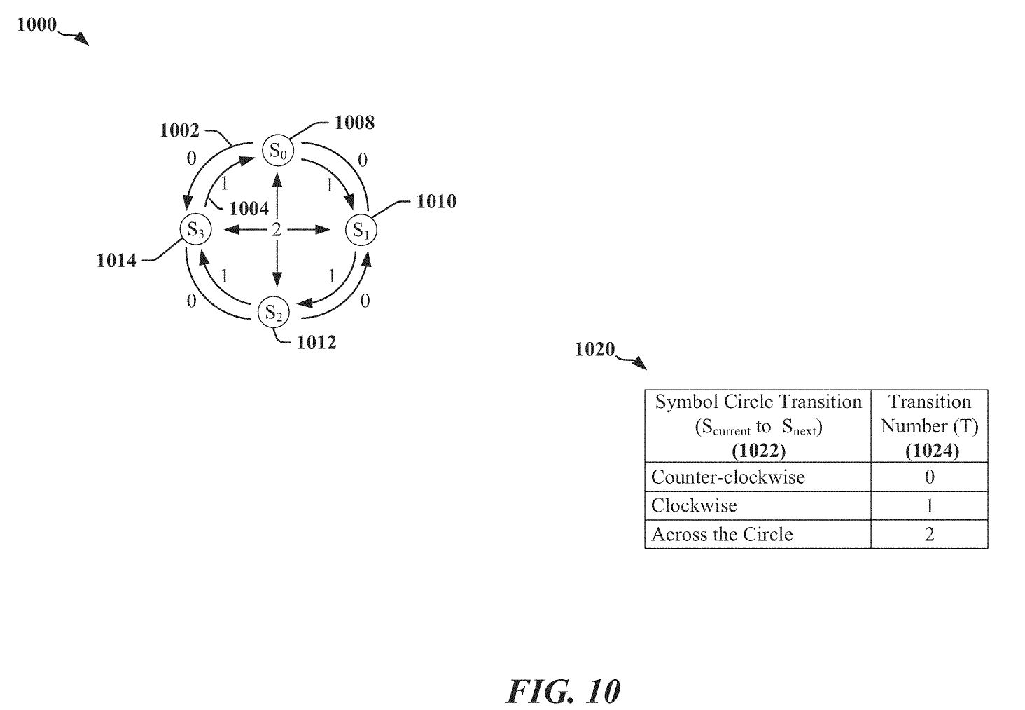

FIG. 10 illustrates a second example of an encoding scheme employing symbol transition encoding on a two-wire serial bus 330. In this example, a variation of ternary-based number coding is employed in accordance with I3C HDR protocols. It is contemplated that certain concepts associated with symbol transitioning may be expanded to include an I3C serial bus that has three or more wires. Septenary-based number coding may be used when three wires are available for transmitting symbols, pentadecimal-based number coding may be used when four wires are available for transmitting symbols, and so on. In the two-wire example (see also FIGS. 7-9), the transition numbers 1024 generated by an encoder (e.g. the transcoder 302 in FIG. 3) may be represented as a displacement value 1022 on and across a circle 1000. A clockwise displacement may be represented as a ternary value T=1, a counter-clockwise displacement may be represented as a ternary value T=0, and a displacement across the circle 1000 (i.e., 2 steps clockwise or counterclockwise) may be represented as a ternary value T=2.

Other symbol encoding schemes may be implemented for two wire implementations and/or for implementations using more than two wires. In one example for N wires (W1 . . . WN), where N≥3, for three or more wires, encoding may be characterized by the transition number formula:

{(W1_{S} XNOR W1_{S-1}),(W2_{S} XNOR W2_{S-1}), . . . (WN_{S} XNOR WN_{S-1})},

for two consecutive states S and S−1.

### Multi-Lane Serial Bus

Various examples discussed herein may be based on, or refer to a MIPI-defined I3C bus, and to HDR-DDR and HDR Ternary modes. The use of MIPI I3C HDR-DDR mode and other I3C modes are referenced as examples only, and the principles disclosed herein are applicable in other contexts.

In some instances, enhanced capability and speed increases may be obtained by the addition of one or more supplementary lines or wires, enabling a change in the coding base to higher numbers. For example, in addition to a two-wire bus, many I2C legacy systems use one or more dedicated interrupt lines between a master device and one or more slave devices. These dedicated interrupt lines may be repurposed (along with the two-wire bus) when the master device switches from a predefined base protocol (e.g., I2C) to a second protocol in which data symbols are encoded across the two-wire bus and one or more dedicated interrupt lines.

In one example, data may be encoded using transition encoding to obtain symbols for transmission over a two-line serial bus and one or more additional lines. When a single additional line is available, the second protocol can transmit 8 symbols over 3 wires (as compared to only 4 symbols over 2 wires), thus allowing for coding in base 7.

In another example, when a two-line I3C bus operated in SDR mode or HDR-DDR mode can be extended with one or more additional lines, data can be transmitted on the additional lines in accordance with the timing provided by a clock signal transmitted on the Clock line.

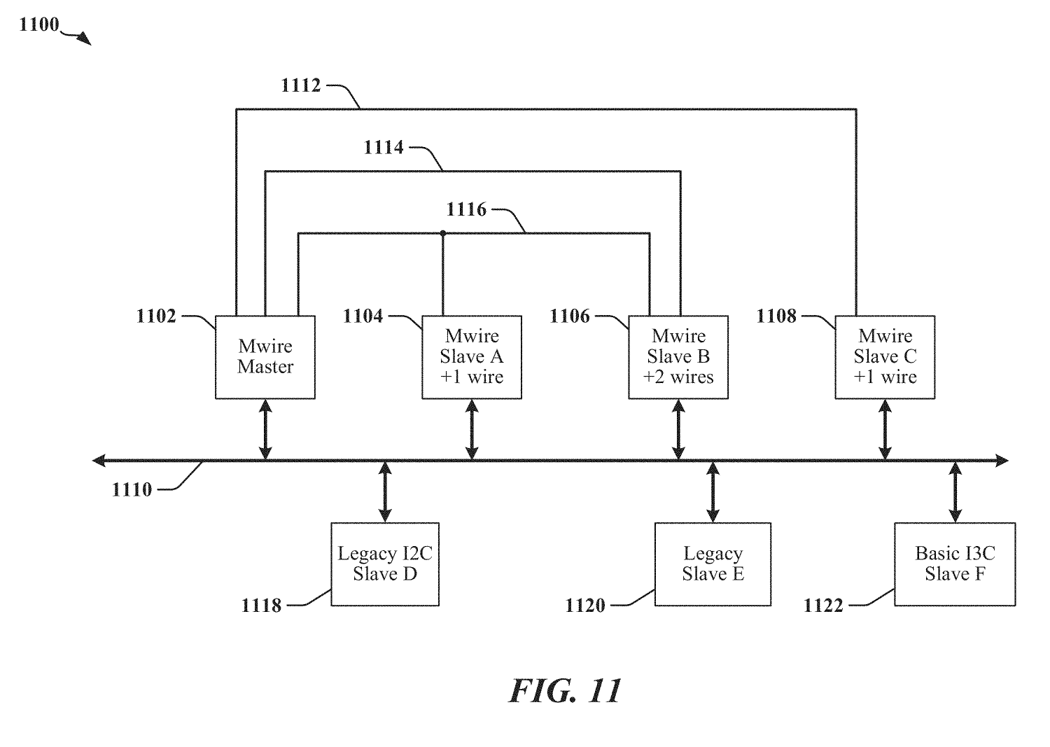

FIG. 11 illustrates a serial bus 1100 in which more than two lines, wires or other connectors may be available for timeshared communication between devices 1102, 1104, 1106, and/or 1108. Devices 1102, 1104, 1106, and/or 1108 that can support communication over an expanded serial bus that includes additional lines or wires may be referred to as multi-wire (Mwire) devices or multi-lane devices. Note that the terms “connector”, “wire” and “line” may be interchangeably used herein to refer to an electrically conductive path. In some instances, a “connector”, “wire”, and “line” may apply to an optically conductive path. In addition to the common lines 316, 318 of a 2-wire I3C bus, additional connectors or wires 1112, 1114, and/or 1116 may be employed to couple an Mwire master device 1102 to one or more Mwire slave devices 1104, 1106, and/or 1108 separately from a two-wire bus 1110, which may be operable in accordance with an I3C protocol. In one example, one Mwire slave device 1108 may be connected to the Mwire master device 1102 using a single, dedicated additional connector or wire 1112. In another example, one Mwire slave device 1104 may be connected to the Mwire master device 1102 using a single, shared additional connector or wire 1116. In another example, one Mwire slave device 1106 may be connected to the Mwire master device 1102 using two or more dedicated and/or shared additional connectors or wires 1114 and 1116. The number, type and arrangement of additional connectors or wires 1112, 1114, and/or 1116 can be selected to balance bandwidth and power consumption for communications between Mwire devices 1102, 1104, 1106, and/or 1108. In some instances, the additional connectors may include optical or other types of connectors.

In an expanded serial bus that includes additional lines or wires, a number of lanes may be configured for communication. In one example, a single wire may provide a clock lane that carries a clock signal or other signal that provides timing information for data transmissions. In another example, plural wires may be configured to carry one or more data lanes based on the mode of communication. In some examples, multiple data lanes may be defined or configured when a serial bus is operated in accordance with an I3C SDR or I3C HDR-DDR protocol. In one example, two or more wires may be configured as a single data lane when data is encoded in a symbol transmitted over the two or more wires in accordance with an I3C HDR-Ternary protocol.

According to certain aspects, any number of wires that is greater than two physical lines can be used in an I3C interface. Two of the wires may be common wires, such as the Clock line 316 and Data line 318 wires that are used for communicating with legacy devices 1118, 1120, 1122 that are not configured for multi-lane operation. Legacy devices 1118, 1120, 1122 may include an I2C device 1118, an I3C device 1122, or another type of device 1120 that uses a two-wire protocol compatible with other devices 1102, 1104, 1106, 1108, 1118, 1122 coupled to the shared two-wire bus 1110.

Bus management messages may be included in shared bus management protocols implemented on the Mwire-capable devices 1102, 1104, 1106, and 1108. Bus management messages may be transferred between Mwire-capable devices 1102, 1104, 1106, and 1108 using the shared two-wire bus 1110. Bus management messages may include address arbitration commands and/or messages, commands and/or messages related to data transport mode entry and exit, commands and/or messages used in the exchange of configuration data including, for example, messages identifying supported protocols, number and allocation of available physical wires, and commands and/or messages that are to negotiate or select a mode of communications.

As illustrated in FIG. 11, different legacy client devices 1118, 1120, 1122 that have more basic signaling capabilities may be supported by the I3C interface. The devices 1102, 1104, 1106, 1108, 1118, 1120, 1122 coupled to the shared two-wire bus 1110 may be compatible with at least one common mode of communication (e.g., predefined base protocol over the two-wire bus 1110). In one example the predefined base protocol (e.g., lowest common denominator protocol), may support an I2C mode of communication. In this latter example, each of the devices 1102, 1104, 1106, 1108, 1118, 1120, 1122 may be adapted to at least recognize start and stop conditions defined by the predefined base protocol.

Two or more devices 1102, 1104, 1106, 1108, 1120, and/or 1122 may communicate using a second protocol (e.g., I3C SDR, I3C HDR-DDR, I3C HDR-Ternary) that is not supported by some of the other devices coupled to the shared two-wire bus 1110. The two or more devices 1102, 1104, 1106, 1108, 1118, 1120, 1122 may identify capabilities of the other devices using the predefined base protocol (e.g., an I2C protocol), after an I3C exchange is initiated, and/or through signaling on one or more additional connectors or wires 1112, 1114 and/or 1116. In at least some instances, the configuration of devices coupled to the shared two-wire bus 1110 may be predefined in the devices 1102, 1104, 1106, 1108, 1118, 1120, 1122.

The additional connectors or wires 1112, 1114 and/or 1116 may include multipurpose, reconfigurable connectors, wires, or lines that connect two or more of the Mwire devices 1102, 1104, 1106, 1108. The additional connectors or wires 1112, 1114 and/or 1116 may include repurposed connections that may otherwise provide inter-processor communications capabilities including, for example interrupts, messaging and/or communications related to events. In some instances, the additional connectors or wires 1112, 1114 and/or 1116 may be provided by design. In one example, the predefined base protocol may utilize the additional connectors or wires 1112, 1114 and/or 1116 for sending interrupts from the slave devices to the master device. In the second protocol, the additional connectors or wires 1112, 1114 and/or 1116 may be repurposed to transmit data in combination with the two-wire bus. The term “data lane” may be used herein to refer to a data line or wire used to communicate data when a device can support multiple data lines or wires (multiple data lanes).

Master and Slave roles are typically interchangeable between Mwire devices 1102, 1104, 1106, 1108, and FIG. 5 relates to a single interaction between two or more of the devices 1102, 1104, 1106, 1108, and/or 1122. As illustrated, the current master device 1102 can support extended communication capabilities with the other Mwire devices 1104, 1106, 1108, using a combination of the additional connectors or wires 1112, 1114, and 1116. The master device 1102 is connected to two slave devices 1104 and 1108 using a single additional connector or wire 1116 and 1112, respectively. The master Mwire device 1102 is connected to one slave device 1106 using a pair of additional connectors or wires 1114 and 1116. Accordingly, the master device 1102 may be configured to select a number of wires for communication based on the capabilities of all slave devices 1104, 1106, and/or 1108 that are involved in a transaction. For example, the master device 1102 may send data to the first Mwire slave device B 1106 using the two-wire bus 1110 plus both additional connectors or wires 1114 and 1116. Additionally, the master device 1102 may send data to the second Mwire slave device A 1104 using the two-wire bus 1110 and a first additional connector or wire 1116.

Data transmitted between two or more Mwire-capable devices 1102, 1104, 1106, and/or 1108 may be encoded using an adapted encoding scheme. One aspect provides for adapting a transition encoding scheme (e.g., I3C HDR-Ternary) to encode data over three or more wires by repurposing any additional available wires, connectors, or lines between a master device and a slave device. In this manner, the two-wire bus 1110 and one or additional connectors or wires 1112, 1114, and/or 1116 may be used to transmit data using all data wires for I3C SDR and I3C HDR-DDR modes, and data may be encoded in symbols for transmission over clock and all data wires in HDR-Ternary mode.

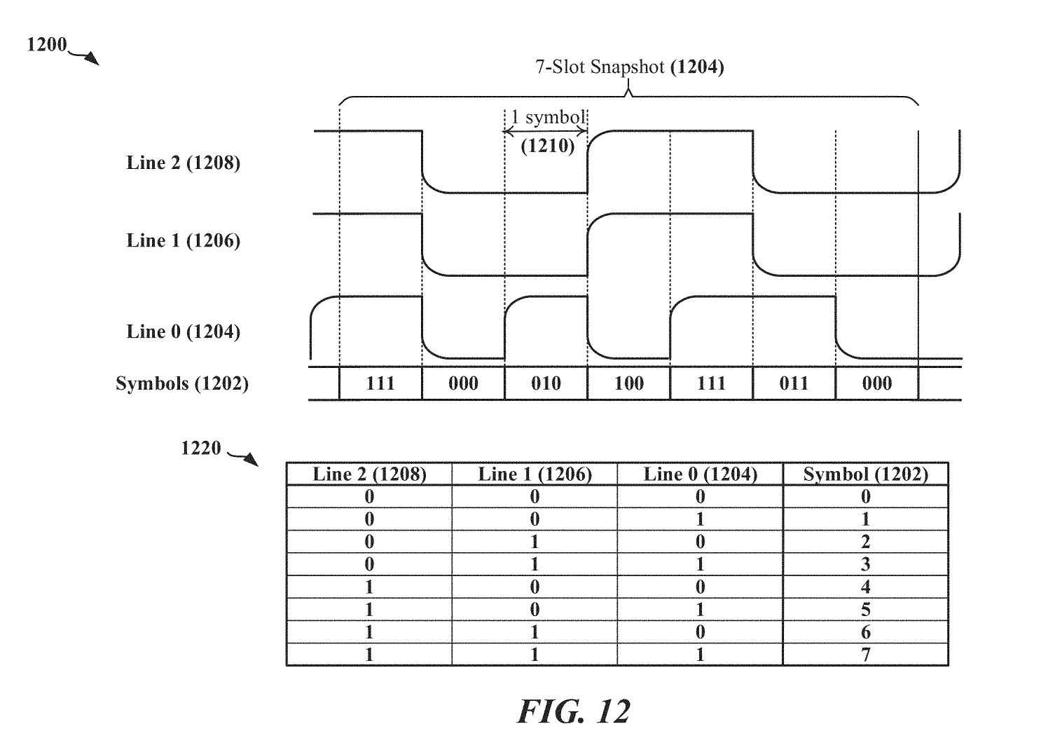

In a first Mwire example, data may be encoded in 3-bit symbols when three connectors, lines or wires 316, 318, 1112, 1114, and/or 1116 are available, and data may be encoded in 4-bit symbols when four connectors, lines or wires 316, 318, 1112, 1114, and/or 1116 are available, and so on. FIG. 12 provides an example 1200 illustrating the encoding of data in symbols across three conductors or wires. A sequence of 7 symbols is illustrated, although data elements may be encoded in any number of symbols and/or symbols having any number of wires, lines or connectors. In the example, data is encoded in three-bit symbols 1202 that control the signaling state of three connectors 1204, 1206 and 1208 in each time slot 1210 corresponding to a symbol transmission interval. The table 1220 illustrates one example of mapping three-bit symbols 1202 to signaling states that can have one of two levels. Transmit clock information may be encoded in the transitions in signaling state between consecutive symbols. In one example, the clock information may be embedded in signaling states transitions of the common connectors, wires or lines 316, 318, with the additional connector or wires 1112, 1114, and/or 1116 being used to carry one additional bit in each symbol. However, certain devices 1102, 1104, 1106 or 1108 may be configured to increase data throughput even further by extracting clock information from transitions that occur on any of the connectors used in a communications transaction.

In the example of a three-wire connection, 8 possible symbols can be defined, as illustrated in the table 1220 of FIG. 12. Consequently, there are 7 possible transition characters, {T₀ . . . T₆} for each transition between symbols, when a transition is to be guaranteed at each boundary between consecutive symbols. A transition number can be formed that has 12 Base-7 digits (i.e., septenary numbering scheme). In the general case discussed herein, a transition number having N digits with r possible transitions for each digit has a total of r^{N} states. In the example of a 12-digit transition number transmitted on an I3C, there are a total of r=8−1=7 possible transitions for each of the N=12 digits, providing a total of 7¹²=13841287201 different states, which may be expressed as the hexadecimal number 0x52801AE1. Consequently, the 12-digit transition number can encode a 33-bit binary numbers, which may use 8,589,934,592 states. The remaining 5251352610 states may be used to carry control codes, or the like.

In an Mwire example involving I3C SDR or I3C HDR-DDR, data may be transmitted over two connectors, lines or wires 316, 318, 1112, 1114, and/or 1116 when one additional wire is available, and data may be transmitted over 4 connectors, lines or wires 316, 318, 1112, 1114, and/or 1116 when 3 additional wires are available, and so on.

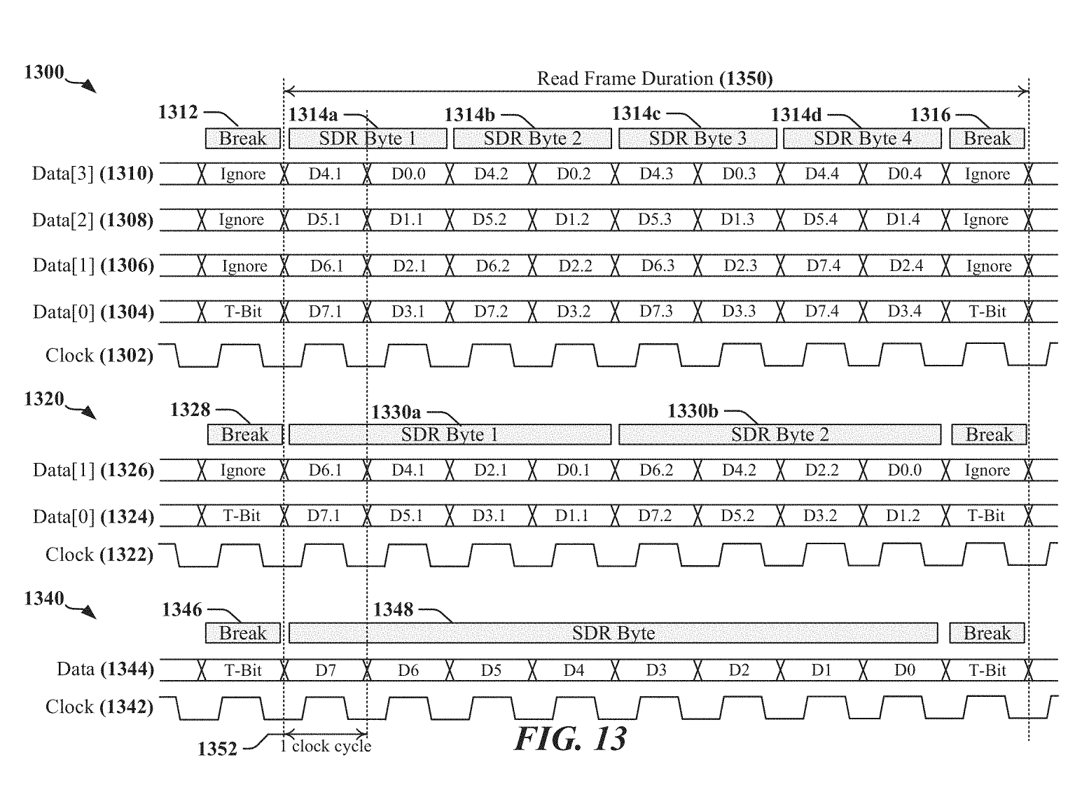

FIG. 13 provides examples 1300, 1320, 1340 illustrating the transmission of data over an I3C serial bus operated in an SDR mode when two or more devices can be coupled to additional connectors, lines or wires 1112, 1114, and/or 1116. In SDR mode, one bit may be transmitted on each data lane 1304, 1306, 1308, 1310, 1324, 1326, 1344 in a single clock cycle 1352. A clock cycle 1352 may correspond to the period of a clock signal transmitted on the clock lanes 1302, 1322, 1342. In each example, 1300, 1320, 1340 a common transaction and/or frame duration 1350 is maintained regardless of the number of additional wires used. For example, a transaction that involves the use of 2 data wires and one clock wire can communicate twice as many bits as a transaction that uses 1 data wire and one clock signal. The additional bits may include payload data bits, parity bits, other protocol-defined bits and/or other information. In some instances, a parity bit may be transmitted on each wire concurrently with a single clock pulse. The maintenance of a common transaction and/or frame duration 1350 can maintain a constant separation between break points 1312, 1316 (T-bits), and devices coupled to the bus and configured for a conventional two-wire mode of operation remain unaware of the use of additional wires. The common transaction and/or frame duration 1350 may effectively define a cadence for bus operations.

In the first example 1340, no additional wires are used and communication proceeds using two wires (Clock and one Data wire). A serialized data byte 1348 may be transmitted after a T-bit and breaking point 1346. In another example 1320, one additional wire is used and communication proceeds using three wires (Clock and two Data wires). Two data bytes 1330a, 1330b may be transmitted after a T-bit and breaking point 1328. In the example, the data bytes 1330a, 1330b are transmitted in a striped mode, whereby a first data byte 1330a is completely transmitted in two-bit nibbles on the two data wires before the second data byte 1330b is transmitted. In other implementations, data bytes may be transmitted in parallel on the two data wires. In another example 1300, three additional wires are used and communication proceeds using five wires (Clock and four Data wires). Four data bytes 1314a, 1314b, 1314c and 1314d may be transmitted after a T-bit and breaking point 1312. In the example, the data bytes 1314a, 1314b, 1314c, 1314d are transmitted in a striped mode, whereby a first data byte 1314a is completely transmitted in four-bit nibbles on the four data wires before the second data byte 1314b is transmitted. In other implementations, data bytes may be transmitted in parallel on the four data wires. In each of the examples 1300, 1320, 1340 in FIG. 13, data is clocked on one edge of each clock pulse in the clock signal, in accordance with I3C SDR protocols.

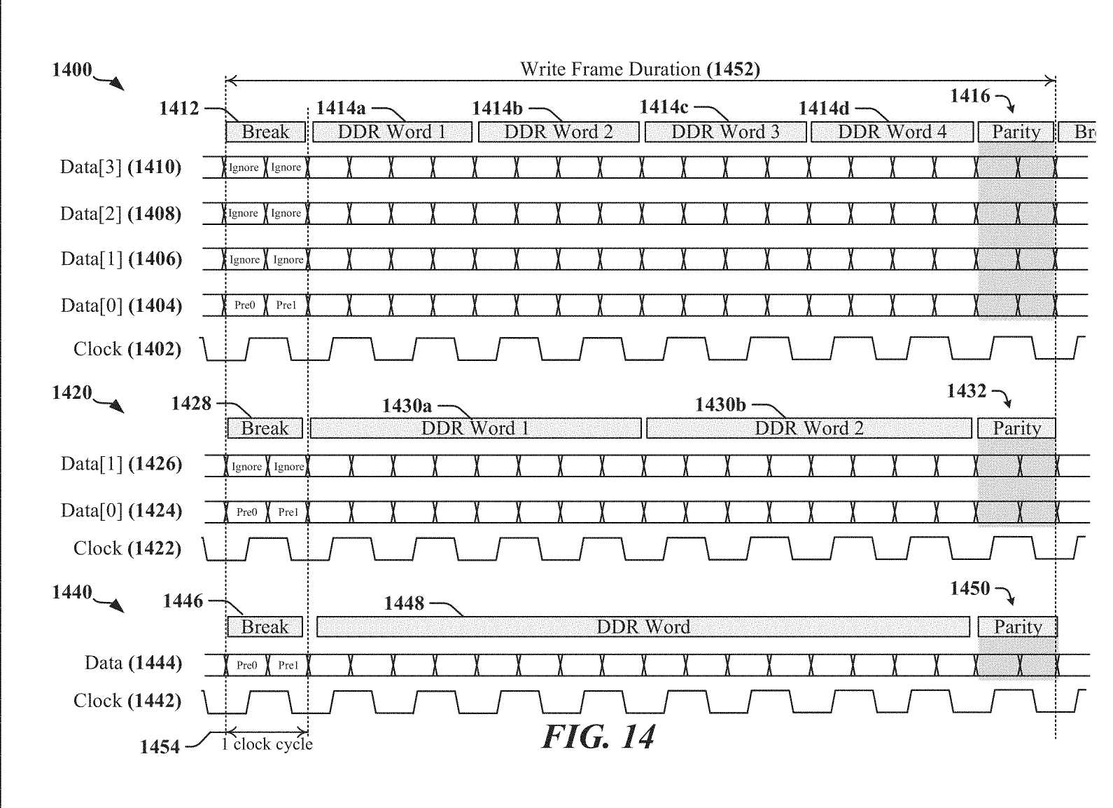

FIG. 14 relates to an HDR-DDR mode of operation in which data is clocked on both edges of each clock pulse in the clock signal. FIG. 14 illustrates examples 1400, 1420, 1440 of data transmission data over an I3C serial bus operated in HDR_DDR mode when two or more devices can be coupled to additional connectors, lines or wires 1112, 1114, and/or 1116. In HDR_DDR mode, two bits may be transmitted on each data lane 1404, 1406, 1408, 1410, 1424, 1426, 1444 in a single clock cycle 1454. A clock cycle 1454 may correspond to the period of a clock signal transmitted on the clock lanes 1402, 1422, 1442.

In each example, 1400, 1420, 1440 a common transaction and/or frame duration 1452 is maintained regardless of the number of additional wires used. For example, a transaction that involves the use of 2 data wires and one clock wire can communicate twice as many bits as a transaction that uses 1 data wire and one clock signal. The additional bits include payload data bits, parity bits, other protocol bits, and/or other information. For example, parity bits 1416, 1432, 1450 are transmitted concurrently with a single clock pulse on each data wire. The parity bits 1416, 1432, 1450 are transmitted in the same time-slot (relative to the start of the transaction or frame) in each example 1400, 1420, 1440. The maintenance of a common transaction and/or frame duration 1350 can maintain a constant separation between break points 1312, 1316 (T-bits), and devices coupled to the bus and configured for a conventional two-wire mode of operation remain unaware of the use of additional wires. The common transaction and/or frame duration 1350 may effectively define a cadence for bus operations.

In the first example 1440, no additional wires are used and communication proceeds using two wires (Clock and one Data wire). A serialized 16-bit data word 1448 may be transmitted after two preamble bits and breaking point 1446. Two parity bits 1450 may be transmitted after the data word 1448. In a second example 1420, one additional wire is used and communication proceeds using three wires (Clock and two Data wires). Two 16-bit data words 1430a, 1430b may be transmitted after two preamble bits and breaking point 1428. Two parity bits 1450 may be transmitted on each data wire after the data words 1430a, 1430b, providing a total of four parity bits. In the example, the data words 1430a, 1430b are transmitted in a striped mode, whereby a first data word 1430a is completely transmitted in two-bit nibbles on the two data wires before the second data word 1430b is transmitted. In other implementations, data words may be transmitted in parallel on the two data wires. In another example 1400, three additional wires are used and communication proceeds using five wires (Clock and four Data wires). Four data words 1414a, 1414b, 1414c and 1414d may be transmitted after two preamble bits and breaking point 1412. In the example, the data words 1414a, 1414b, 1414c, 1414d are transmitted in a striped mode, whereby a first data word 1414a is completely transmitted in four-bit nibbles on the four data wires before the second data word 1414b is transmitted. In other implementations, data words may be transmitted in parallel on the four data wires. The preamble bits are typically transmitted on the primary data wire of the two-wire I3C bus, and signaling state of the additional connectors, lines or wires 1112, 1114, and/or 1116 may be ignored by a receiver.

The examples 1400, 1420, 1440 illustrated in FIG. 14 provide a number of parity bits that can be used to provide enhance error detection and correction capabilities. In one example, the parity bits transmitted on the data wire of the on the base 2-wire I3C are preserved and configured in accordance with I3C specifications. For example, a 2-bit cyclic redundancy check for the preceding data words 1448, 1430a-1430b, 1414a-1414d may be transmitted in the two-bit field designated by the I3C Specifications. In another example, a two-bit CRC can be transmitted on each additional data lane, calculated from the bits transmitted over the corresponding additional data lane. In another example, a CRC sized according to the number of available parity bits may be calculated from the preceding data words 1448, 1430a-1430b, 1414a-1414d bits. For example, a two-bit CRC may be transmitted when no additional data lanes are available, a four-bit CRC may be transmitted when one additional data lane is available, and an eight-bit CRC may be transmitted when three additional data lanes are available. In another example, the parity bits may be used to implement a block-parity error detection and correction scheme.

As illustrated in certain of the examples, a multilane (ML) extension of an I3C bus may be implemented to provide increased data throughput, while keeping the I3C Interface bus management procedures. I3C frame settings are preserved to provide break points 1312, 1328, 1346, 1412, 1428, 1446 at the expected time defined by the conventional I3C specifications. The ML version of the I3C interface permits devices of single, dual or quad data lanes to be connected on the same two-wire base lanes. ML-capable devices can be enabled a priori, with available data lanes enabled or supported.

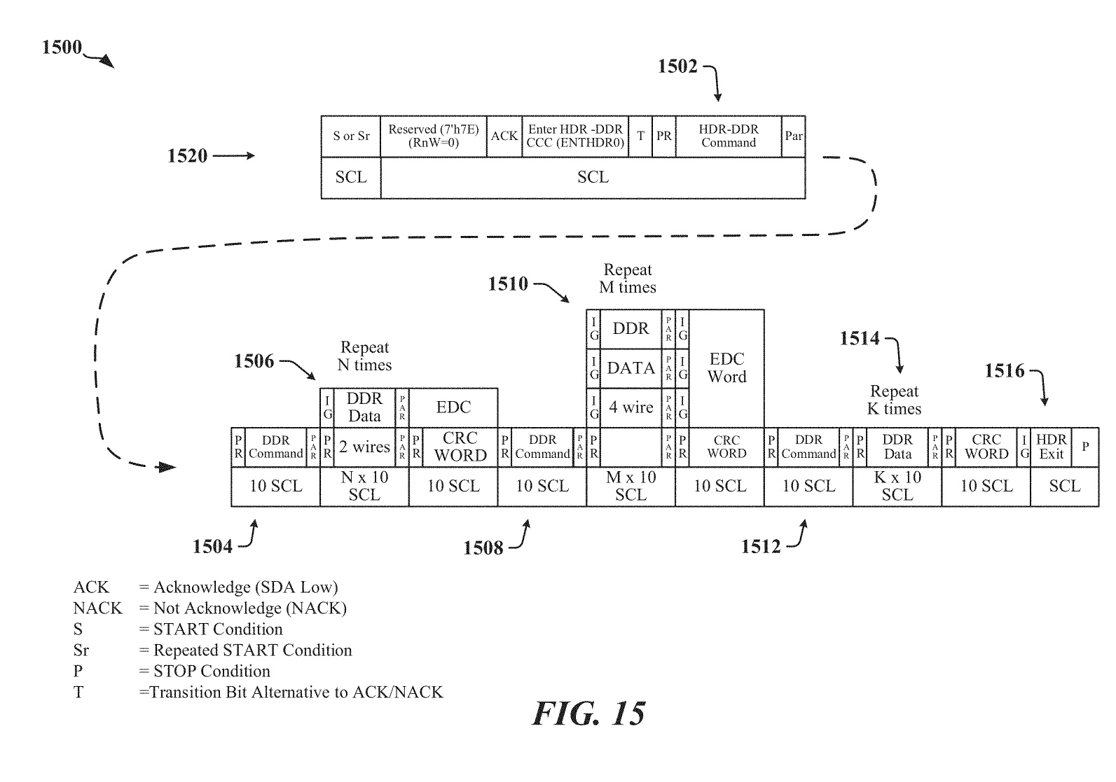

According to certain aspects, an ML version of an I3C bus may be dynamically switched between modes of operation and may select a number of data lanes, or symbol bit-size for use between ML-enabled devices. FIG. 15 is an example of a timeline 1500 illustrating the operation of an ML-enabled I3C bus. The I3C bus may initially be configured for a mode of operation supported by all devices coupled to the I3C bus, which may be SDR mode for example. An initial transmission 1520, that includes a first command 1502 may be initiated in the SDR mode. In one example, the first command 1502 includes a common command code (CCC) that causes one or more devices coupled to the I3C bus to be operated in HDR-DDR mode. A second command 1504 is transmitted in HDR-DDR mode to select a bus width and other parameters for a first transaction 1506 to be executed in the HDR-DDR mode. In the illustrated example, the second command 1504 causes data to be transmitted over the I3C bus and one additional wire. The first transaction 1506 may include transmission of a number (N) of 16-bit data words followed by a CRC word. In some instances, the one or more devices may remain in the HDR-DDR mode and/or may continue to use the selected bus width until one or more new commands are transmitted that cause the one or more devices to modify mode of operation and/or bus width.

In some implementations, the number of wires used by devices may be preconfigured during manufacture, assembly and/or system configuration. In at least some instances, commands may be transmitted to modify preconfigured definitions of bus width.

A third command 1508 is transmitted in HDR-DDR mode to select a bus width and other parameters for a second transaction 1510 to be executed in the HDR-DDR mode. In the illustrated example, the third command 1508 causes data to be transmitted over the I3C bus and three additional wires. The second transaction 1510 may include transmission of a number (M) of 16-bit data words followed by a CRC word. A fourth command 1512 is transmitted in HDR-DDR mode to select a bus width and other parameters for a third transaction 1514 to be executed in the HDR-DDR mode. In the illustrated example, the fourth command 1512 causes data to be transmitted over the I3C bus and no additional wires. The second transaction 1510 may include transmission of a number (K) of 16-bit data words followed by a CRC word.

### Frame Structures for a Multi-Lane Serial Bus

In accordance with certain aspects disclosed herein, the arrange of data transmitted in frames over a multi-lane serial bus may be configured based on protocol or application requirements. For example, bytes of data may be assigned to specific data lanes according to source, such that an individual lane or group of lanes may operate as defined channel. In another example, and as illustrated in FIG. 13, data bytes may be transmitted in a striped mode, whereby a first data byte is transmitted in nibbles spread across all available lanes of a multi-lane bus.

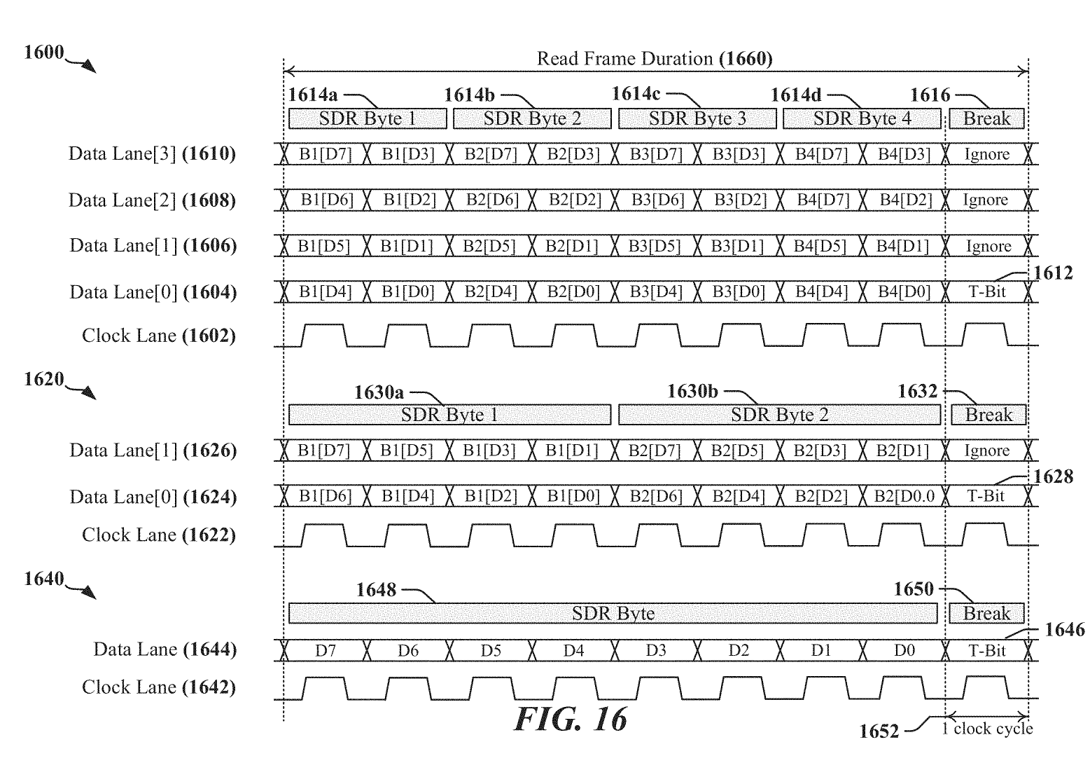

Different allocations of bits in a multi-byte frame transmitted over a multi-lane serial bus may be selected when data is striped across multiple lanes. FIG. 16 illustrates datagram structures 1600, 1620, 1640 that may be received during a device read. The datagram structures 1600, 1620, 1640 of FIG. 16 correspond to the datagram structures illustrated in the examples 1300, 1320, 1340 illustrated in FIG. 13. The allocation of bits in the multi-lane datagram structures 1600, 1620 of FIG. 16 is different from the allocation of bits in the corresponding datagram structures illustrated in the examples 1300, 1320 of FIG. 13.

FIG. 16 illustrates data exchanges over an I3C serial bus operated in an SDR mode when two or more devices can be coupled to additional connectors, lines or wires. In the SDR mode, one bit may be transmitted on each data lane 1604, 1606, 1608, 1610, 1624, 1626, 1644 in a single clock cycle 1652. A clock cycle 1652 may correspond to the period of a clock signal transmitted on the clock lanes 1602, 1622, 1642.

In each datagram structure 1600, 1620, 1640 a common transaction and/or frame duration 1660 is maintained regardless of the number of additional data lanes used. For example, a transaction that involves the use of two data lanes and one clock line can communicate twice as many bits as a transaction that uses one data lane and one clock signal. Additional bits may be transmitted, including payload data bits, parity bits, control bits, command bits, other protocol-defined bits and/or other information. In some implementations, devices coupled to the bus and configured for a conventional two-line mode of operation remain unaware of the use of additional data lanes. In some instances, a parity bit may be transmitted on each data lane concurrently with a single clock pulse. In some implementations, a common transaction and/or frame duration 1660 can be provided using break points 1616, 1632, 1650 to separate frames. The break points 1616, 1632, 1650 may be defined by transmission of T-bits 1612, 1628, 1646 in at least one data lane. The common transaction and/or frame duration 1660 may define a cadence for bus operations.

In the first datagram structure 1640, no additional data lanes are used and communication proceeds using two lanes (clock lane 1642 and one data lane 1644). A serialized data byte 1648 may be terminated at a breaking point 1650 defined by a T-bit 1646 transmitted on the data lane 1644.

In a second datagram structure 1620, one additional data lane is used and communication proceeds using three lanes (clock lane 1622 and two data lanes 1624, 1626). Two data bytes 1630a, 1630b may be terminated at a breaking point 1632 defined by a T-bit 1628 transmitted on one of the data lanes 1626, 1624. In the example, the data bytes 1630a, 1630b are transmitted in a striped mode, whereby a first data byte 1630a is completely transmitted in two-bit nibbles on the two data lanes before the second data byte 1630b is transmitted. In other implementations, data bytes may be transmitted in parallel on the two data lanes.

In another datagram structure 1600, three additional data lanes are used and communication proceeds using five lanes (clock lane 1602 and four data lanes 1604, 1606, 1608, 1610). Four data bytes 1614a, 1614b, 1614c and 1614d may be terminated at a breaking point 1616 defined by a T-bit 1612 transmitted on one of the data lanes 1604, 1606, 1608, 1610. In the example, the data bytes 1614a, 1614b, 1614c, 1614d are transmitted in a striped mode, whereby a first data byte 1614a is completely transmitted in four-bit nibbles on the four data lanes before the second data byte 1614b is transmitted. In other implementations, data bytes may be transmitted in parallel on the four data lanes. In each of the datagram structures 1600, 1620, 1640 in FIG. 16, data is clocked on one edge of each clock pulse in the clock signal transmitted on the clock lane 1602, 1622, 1642, in accordance with I3C SDR protocols.

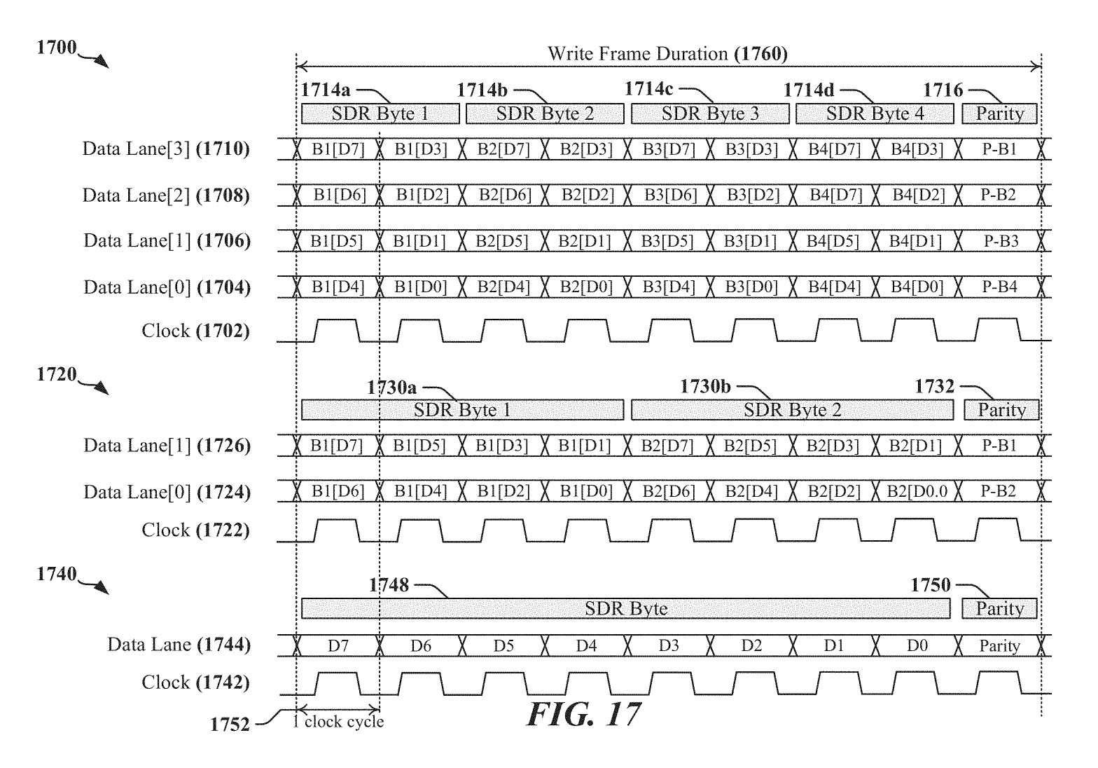

FIG. 17 illustrates examples of datagram structures 1700, 1720, 1740 that may be transmitted during a device write where parity is transmitted with each byte of data. FIG. 17 illustrates data exchanges over an I3C serial bus operated in an SDR mode when two or more devices can be coupled to additional connectors, lines or wires. In the SDR mode, one bit may be transmitted on each data lane 1704, 1706, 1708, 1710, 1724, 1726, 1744 in a single clock cycle 1752. A clock cycle 1752 may correspond to the period of a clock signal transmitted on the clock lanes 1702, 1722, 1742.

In each datagram structure 1700, 1720, 1740, a common transaction and/or frame duration 1760 is maintained regardless of the number of additional data lanes used. For example, a transaction that involves the use of two data lanes and one clock lane can communicate twice as many bits as a transaction that uses one data lane and one clock signal. In the examples illustrated in FIG. 17, a parity bit may be transmitted on each data lane concurrently and in accordance with a common clock pulse. Parity transmissions 1716, 1732, 1750 occurs after transmission of data bytes 1714a-1714d, 1730a-1730b, 1748. Allocation of parity bits to data lanes may be configured based on application needs and/or circuit design.

In the first datagram structure 1740, no additional data lanes are used and communication proceeds using two lanes (clock lane 1742 and one data lane 1744). A serialized data byte 1748 may be terminated after a parity transmission 1716 of a parity bit on the data lane 1744.

In a second datagram structure 1720, one additional data lane is used and communication proceeds using three lanes (clock lane 1722 and two data lanes 1724, 1726). Two data bytes 1730a, 1730b may be terminated after a parity transmission 1732 including up to two parity bits transmitted on the data lanes 1726, 1724. In the example, the data bytes 1730a, 1730b are transmitted in a striped mode, whereby a first data byte 1730a is completely transmitted in two-bit nibbles on the two data lanes before the second data byte 1730b is transmitted. In other implementations, data bytes may be transmitted in parallel on the two data lanes.

In a third datagram structure 1700, three additional data lanes are used and communication proceeds using five lanes (clock lane 1702 and four data lanes 1704, 1706, 1708, 1710). Four data bytes 1714a, 1714b, 1714c and 1714d may be terminated after a parity transmission 1750 including up to four parity bits transmitted on the data lanes 1704, 1706, 1708, 1710. In the example, the data bytes 1714a, 1714b, 1714c, 1714d are transmitted in a striped mode, whereby a first data byte 1714a is completely transmitted in four-bit nibbles on the four data lanes before the second data byte 1714b is transmitted. In other implementations, data bytes may be transmitted in parallel on the four data lanes. In each of the datagram structures 1700, 1720, 1740 in FIG. 17, data is clocked on one edge of each clock pulse in the clock signal transmitted on the clock lane 1702, 1722, 1742, in accordance with I3C SDR protocols.

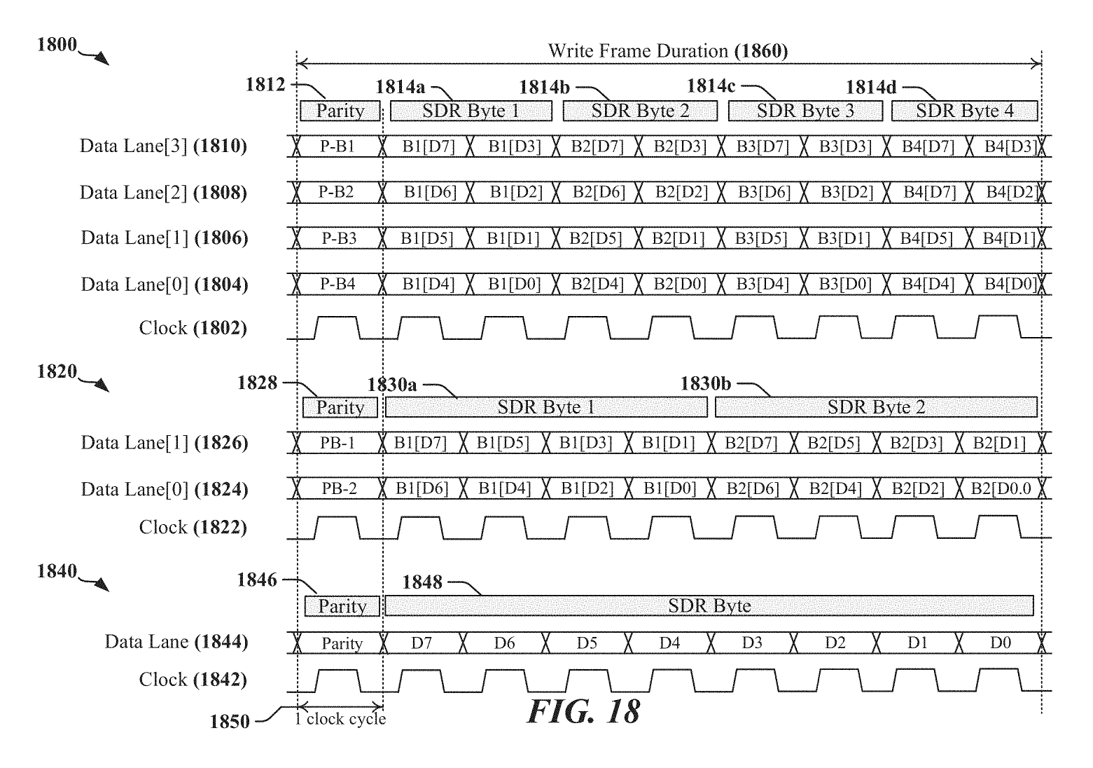

The location of parity transmission within a frame may be configured as desired or needed by application or hardware circuit design. FIG. 18 illustrates examples of datagram structures 1800, 1820, 1840 that may be transmitted during a device write where parity is transmitted with each byte of data. FIG. 18 illustrates data exchanges over an I3C serial bus operated in an SDR mode when two or more devices can be coupled to additional connectors, lines or wires. In the SDR mode, one bit may be transmitted on each data lane 1804, 1806, 1808, 1810, 1824, 1826, 1844 in a single clock cycle 1850. A clock cycle 1850 may correspond to the period of a clock signal transmitted on the clock lanes 1802, 1822, 1842.

In each datagram structure 1800, 1820, 1840, a common transaction and/or frame duration 1860 is maintained regardless of the number of additional data lanes used. For example, a transaction that involves the use of two data lanes and one clock lane can communicate twice as many bits as a transaction that uses one data lane and one clock signal.

In the examples illustrated in FIG. 18, a parity bit may be transmitted on each data lane concurrently and in accordance with a common clock pulse. Parity transmissions 1812, 1828, 1846 occurs before transmission of data bytes 1814a-1814d, 1830a-1830b, 1848. Allocation of parity bits to data lanes may be configured based on application needs and/or circuit design. In the multi-lane configurations of FIG. 18, a receiver possesses all of the parity bits associated with a frame when data bytes 1814a-1814d, 1830a-1830b are received and the receiver can validate the data bytes 1814a-1814d, 1830a-1830b as they are received. When parity bits are received after the data bytes 1814a-1814d, 1830a-1830b, additional storage may be required to hold the data bytes 1814a-1814d, 1830a-1830b until validation.

In the first datagram structure 1840, no additional data lanes are used and communication proceeds using two lanes (clock lane 1842 and one data lane 1844). A serialized data byte 1848 may be transmitted after a parity transmission 1812 where a parity bit is sent on the data lane 1844.

In a second datagram structure 1820, one additional data lane is used and communication proceeds using three lanes (clock lane 1822 and two data lanes 1824, 1826). Two data bytes 1830a, 1830b may be transmitted after a parity transmission 1828 where up to two parity bits are transmitted on the data lanes 1826, 1824. In the example, the data bytes 1830a, 1830b are transmitted in a striped mode, whereby a first data byte 1830a is completely transmitted in two-bit nibbles on the two data lanes before the second data byte 1830b is transmitted. In other implementations, data bytes may be transmitted in parallel on the two data lanes.

In a third datagram structure 1800, three additional data lanes are used and communication proceeds using five lanes (clock lane 1802 and four data lanes 1804, 1806, 1808, 1810). Four data bytes 1814a, 1814b, 1814c and 1814d may be transmitted after a parity transmission 1846 where up to four parity bits transmitted on the data lanes 1804, 1806, 1808, 1810. In the example, the data bytes 1814a, 1814b, 1814c, 1814d are transmitted in a striped mode, whereby a first data byte 1814a is completely transmitted in four-bit nibbles on the four data lanes before the second data byte 1814b is transmitted. In other implementations, data bytes may be transmitted in parallel on the four data lanes. In each of the datagram structures 1800, 1820, 1840 in FIG. 18, data is clocked on one edge of each clock pulse in the clock signal transmitted on the clock lane 1802, 1822, 1842, in accordance with I3C SDR protocols.

In the examples illustrated in FIGS. 17 and 18, the maximum possible bytes are transmitted in multi-lane configurations. In some instances, fewer bytes may be transmitted. For example, the four-lane datagram structure 1800 of FIG. 18 can carry up to four bytes of data. When an odd number of bytes are allocated to one or more datagrams having the datagram structure 1800, then at least one of the datagrams is transmitted with less than four bytes. In certain implementations, the full number of time slots allocated to an unfilled datagram are transmitted to maintain bus cadence.

### Examples of Processing Circuits and Methods

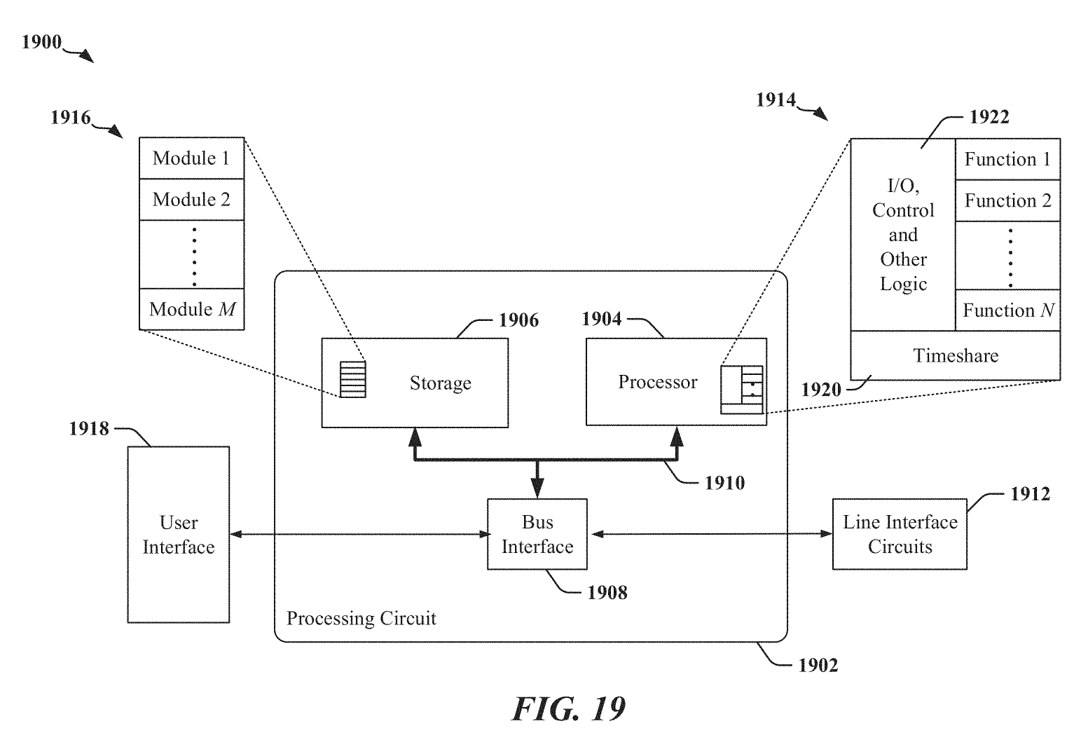

FIG. 19 is a diagram illustrating an example of a hardware implementation for an apparatus 1900 employing a processing circuit 1902 that may be configured to perform one or more functions disclosed herein. In accordance with various aspects of the disclosure, an element, or any portion of an element, or any combination of elements as disclosed herein may be implemented using the processing circuit 1902. The processing circuit 1902 may include one or more processors 1904 that are controlled by some combination of hardware and software modules. Examples of processors 1904 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1904 may include specialized processors that perform specific functions, and that may be configured, augmented or controlled by one of the software modules 1916. The one or more processors 1904 may be configured through a combination of software modules 1916 loaded during initialization, and further configured by loading or unloading one or more software modules 1916 during operation. In various examples, the processing circuit 1902 may be implemented using a state machine, sequencer, signal processor and/or general-purpose processor, or a combination of such devices and circuits.

In the illustrated example, the processing circuit 1902 may be implemented with a bus architecture, represented generally by the bus 1910. The bus 1910 may include any number of interconnecting buses and bridges depending on the specific application of the processing circuit 1902 and the overall design constraints. The bus 1910 links together various circuits including the one or more processors 1904, and storage 1906. Storage 1906 may include memory devices and mass storage devices, and may be referred to herein as computer-readable media and/or processor-readable media. The bus 1910 may also link various other circuits such as timing sources, timers, peripherals, voltage regulators, and power management circuits. A bus interface 1908 may provide an interface between the bus 1910 and one or more transceivers 1912. A transceiver 1912 may be provided for each networking technology supported by the processing circuit. In some instances, multiple networking technologies may share some or all of the circuitry or processing modules found in a transceiver 1912. Each transceiver 1912 provides a means for communicating with various other apparatus over a transmission medium. Depending upon the nature of the apparatus 1900, a user interface 1918 (e.g., keypad, display, speaker, microphone, joystick) may also be provided, and may be communicatively coupled to the bus 1910 directly or through the bus interface 1908.

A processor 1904 may be responsible for managing the bus 1910 and for general processing that may include the execution of software stored in a computer-readable medium that may include the storage 1906. In this respect, the processing circuit 1902, including the processor 1904, may be used to implement any of the methods, functions and techniques disclosed herein. The storage 1906 may be used for storing data that is manipulated by the processor 1904 when executing software, and the software may be configured to implement any one of the methods disclosed herein.

One or more processors 1904 in the processing circuit 1902 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1906 or in an external computer-readable medium. The external computer-readable medium and/or storage 1906 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1906 may also include, by way of example, a carrier wave, a transmission line, and any other suitable medium for transmitting software and/or instructions that may be accessed and read by a computer. Computer-readable medium and/or the storage 1906 may reside in the processing circuit 1902, in the processor 1904, external to the processing circuit 1902, or be distributed across multiple entities including the processing circuit 1902. The computer-readable medium and/or storage 1906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1906 may maintain software maintained and/or organized in loadable code segments, modules, applications, programs, etc., which may be referred to herein as software modules 1916. Each of the software modules 1916 may include instructions and data that, when installed or loaded on the processing circuit 1902 and executed by the one or more processors 1904, contribute to a run-time image 1914 that controls the operation of the one or more processors 1904. When executed, certain instructions may cause the processing circuit 1902 to perform functions in accordance with certain methods, algorithms and processes described herein.

Some of the software modules 1916 may be loaded during initialization of the processing circuit 1902, and these software modules 1916 may configure the processing circuit 1902 to enable performance of the various functions disclosed herein. For example, some software modules 1916 may configure internal devices and/or logic circuits 1922 of the processor 1904, and may manage access to external devices such as the transceiver 1912, the bus interface 1908, the user interface 1918, timers, mathematical coprocessors, and so on. The software modules 1916 may include a control program and/or an operating system that interacts with interrupt handlers and device drivers, and that controls access to various resources provided by the processing circuit 1902. The resources may include memory, processing time, access to the transceiver 1912, the user interface 1918, and so on.

One or more processors 1904 of the processing circuit 1902 may be multifunctional, whereby some of the software modules 1916 are loaded and configured to perform different functions or different instances of the same function. The one or more processors 1904 may additionally be adapted to manage background tasks initiated in response to inputs from the user interface 1918, the transceiver 1912, and device drivers, for example. To support the performance of multiple functions, the one or more processors 1904 may be configured to provide a multitasking environment, whereby each of a plurality of functions is implemented as a set of tasks serviced by the one or more processors 1904 as needed or desired. In one example, the multitasking environment may be implemented using a timesharing program 1920 that passes control of a processor 1904 between different tasks, whereby each task returns control of the one or more processors 1904 to the timesharing program 1920 upon completion of any outstanding operations and/or in response to an input such as an interrupt. When a task has control of the one or more processors 1904, the processing circuit is effectively specialized for the purposes addressed by the function associated with the controlling task. The timesharing program 1920 may include an operating system, a main loop that transfers control on a round-robin basis, a function that allocates control of the one or more processors 1904 in accordance with a prioritization of the functions, and/or an interrupt driven main loop that responds to external events by providing control of the one or more processors 1904 to a handling function.

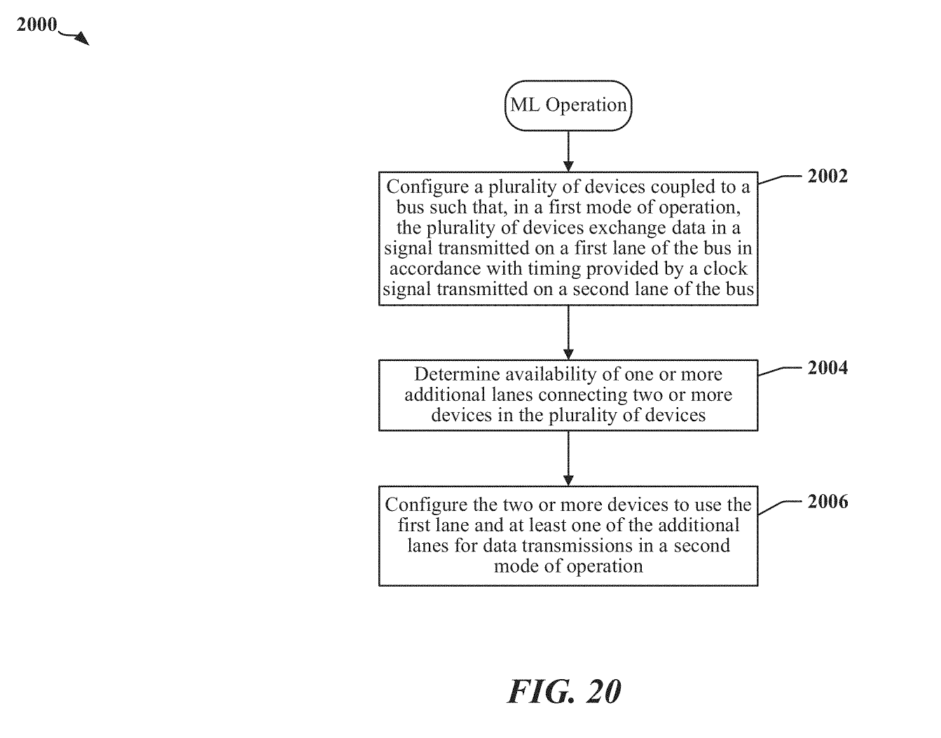

FIG. 20 is a flowchart 2000 illustrating a process that may be performed at a device coupled to a serial bus.

At block 2002, the device may configure a plurality of devices coupled to a bus such that, in a first mode of operation, the plurality of devices exchange data in a signal transmitted on a first lane of the bus in accordance with timing provided by a clock signal transmitted on a second lane of the bus. In one example, a master device 1102 (see FIG. 11) may communicate with one or more slave devices 1104, 1106, 1108 using a basic I3C bus 1110 augmented with one or more additional connectors or wires 1112, 1114, 1116.

At block 2004, the device may determine availability of one or more additional lanes connecting two or more devices in the plurality of devices.

At block 2006, the device may configure the two or more devices to use the first lane and at least one of the additional lanes for data transmissions in a second mode of operation.

In various examples, the device may transmit a command in the first mode of operation to define the second mode of operation as a double data rate mode of operation. The command may define a number of additional lanes to be used for data transmissions in the second mode of operation. Data may be encoded in symbols used to control signaling state of the first lane, the second lane and the one or more additional lanes in the second mode of operation, and the second command defines the number of bits in the symbols. In the second mode of operation, information corresponding to timing of symbol transmissions is embedded in transitions between consecutively transmitted symbols.

In certain examples, the device may transmit a plurality of commands on the bus. Each command may select a mode of operation to be used by one or more devices when communicating over the serial bus. The command may define a number of additional lanes to be used for data transmissions in the corresponding selected mode of operation. Different devices may be configured to communicate using different modes of operation. In some instances, a first device may receive a first command that causes the device to operate in a first mode of operation using a first number of wires. The first device may use the first mode of operation and the first number of wires for multiple transactions conducted over the bus. In some instances, the first device may continue to use the first mode of operation and the first number of wires until a second command causes the first device to operate in a second mode of operation and/or to use a second number of wires.

Each command may be transmitted in the first mode of operation. The device may transmit one or more commands operative to configure each device in the two or more devices to support a number of data lanes. The device may ascertain a number of available lanes coupled to each of the two or more devices. The device may configure each slave device to use at least some of the available lanes in the second mode of operation. The device may dynamically adapt a protocol used in the second mode of operation to utilize a corresponding number of the available lanes when communicating with each slave device. The protocol used in the second mode of operation is adapted to use a varying number of lanes to encode symbols for transmission.

In some instances, data words are striped across lanes used to transmit data signals in the second mode of operation.

In certain examples, a first frame may be transmitted in the first mode of operation using only the first lane and the second lane, and a second frame may be transmitted in the second mode of operation using the first lane, the second lane and the at least one additional lane. The first frame and the second frame may have a common frame duration. The device may transmit first parity bits in the first frame, and second parity bits in the second frame. The first parity bits and the second parity bits may be transmitted in a common time-slot of their respective frames. Time-slots may represent cycles of the clock signal relative to commencement or termination of respective frames. In one example, the first parity and the second parity bits are transmitted during the last of a plurality of clock cycles used to transmit the respective frames. In another example, the first parity bits and the second parity bits are transmitted during the first of the plurality of clock cycles used to transmit the respective frames.

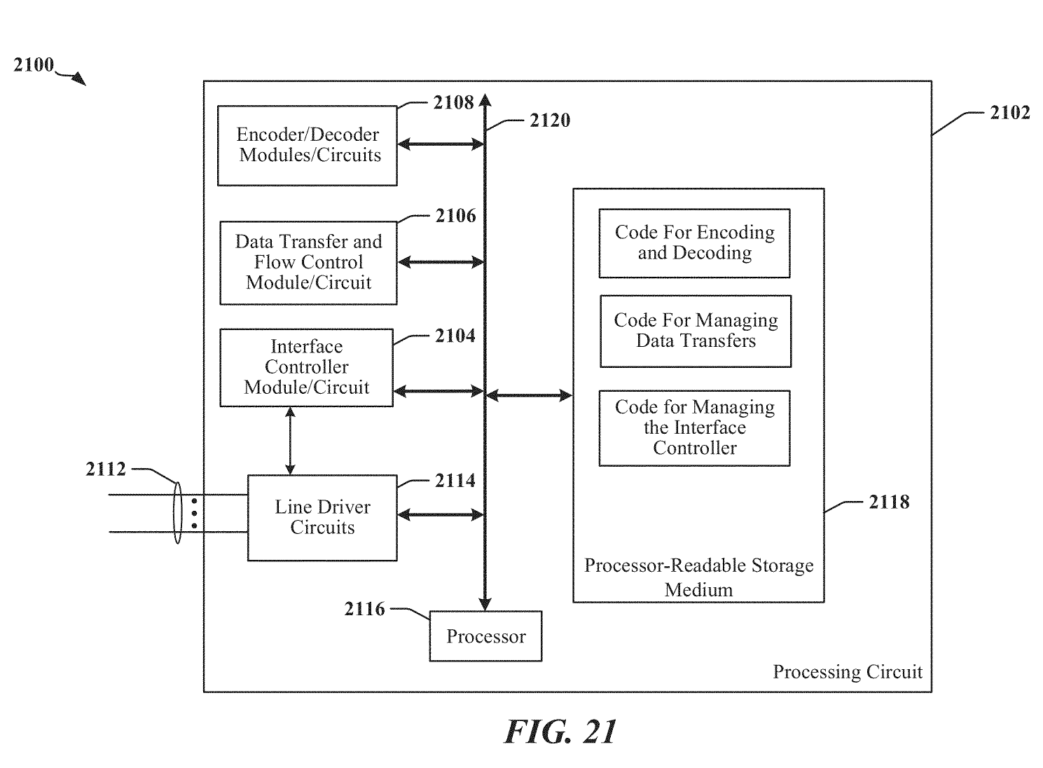

FIG. 21 is a diagram illustrating a simplified example of a hardware implementation for an apparatus 2100 employing a processing circuit 2102. The processing circuit typically has a controller or processor 2116 that may include one or more microprocessors, microcontrollers, digital signal processors, sequencers and/or state machines. The processing circuit 2102 may be implemented with a bus architecture, represented generally by the bus 2120. The bus 2120 may include any number of interconnecting buses and bridges depending on the specific application of the processing circuit 2102 and the overall design constraints. The bus 2120 links together various circuits including one or more processors and/or hardware modules, represented by the controller or processor 2116, the modules or circuits 2104, 2106 and 2108, and the computer-readable storage medium 2118. The apparatus may be coupled to a multi-lane communication link using a physical layer circuit 2114. The physical layer circuit 2114 may operate the multi-lane communication link 2112 to support communications in accordance with I3C protocols. The bus 2120 may also link various other circuits such as timing sources, peripherals, voltage regulators, and power management circuits, which are well known in the art, and therefore, will not be described any further.

The processor 2116 is responsible for general processing, including the execution of software, code and/or instructions stored on the computer-readable storage medium 2118. The computer-readable storage medium may include a non-transitory storage medium. The software, when executed by the processor 2116, causes the processing circuit 2102 to perform the various functions described supra for any particular apparatus. The computer-readable storage medium may be used for storing data that is manipulated by the processor 2116 when executing software. The processing circuit 2102 further includes at least one of the modules 2104, 2106 and 2108. The modules 2104, 2106 and 2108 may be software modules running in the processor 2116, resident/stored in the computer-readable storage medium 2118, one or more hardware modules coupled to the processor 2116, or some combination thereof. The modules 2104, 2106 and 2108 may include microcontroller instructions, state machine configuration parameters, or some combination thereof.

In one configuration, the apparatus 2100 includes an interface controller 2104, and line driver circuits 2114 including a first line driver coupled to a first wire of a multi-lane serial bus and a second line driver coupled to a second wire of the multi-lane serial bus 2112. The apparatus 2100 may include modules and/or circuits 2104, 2108, 2114 configured to transmit first data over the serial bus while the serial bus 2112 is configured for a DDR mode of operation. The apparatus 2100 may include modules and/or circuits 2104, 2106, 2114 configured to exchange data in a signal transmitted on a first lane in accordance with timing provided by a clock signal transmitted on a second lane. The apparatus 2100 may include modules and/or circuits 2104, 2106, 2114 adapted to configure one or more additional lanes connecting two or more devices in a plurality of devices, the two or more devices being configured to use the first lane and at least one of the additional lanes for data transmissions in a second mode of operation.

The apparatus 2100 may transmit a command in the first mode of operation defines the second mode of operation as a double data rate mode of operation. The command may define the number of additional lanes used for data transmissions used in the second mode of operation. Data may be encoded in symbols used to control signaling state of the first lane, the second lane and the one or more additional lanes in the second mode of operation, and the second command defines the number of bits in the symbols. In the second mode of operation, information corresponding to timing of symbol transmissions is embedded in transitions between consecutively transmitted symbols.

In various examples, a plurality of commands is transmitted on the bus, each command selecting a mode of operation for the bus and the number of additional lanes used for data transmissions in each selected mode of operation. Each command may be transmitted in the first mode of operation. Each of the two or more devices may be configured to support a number of data lanes. The two or more devices may be preconfigured by a master device to operate in both the first mode of operation and the second mode of operation. In the second mode of operation, a master device may be adapted to, ascertain a number of available lanes coupled to each of the two or more devices, configure each slave device to use at least some of the available lanes in the second mode of operation, and dynamically adapt a protocol used in the second mode of operation to utilize a corresponding number of the available lanes when communicating with each slave device. The protocol may be used in the second mode of operation is adapted to use a varying number of lanes to encode symbols for transmission.

Data words may be striped across lanes used to transmit data signals in the second mode of operation.

In certain examples, a first frame may be transmitted in the first mode of operation using only the first lane and the second lane, and a second frame may be transmitted in the second mode of operation using the first lane, the second lane and the at least one additional lane. The first frame and the second frame may have a common frame duration. The device may transmit first parity bits in the first frame, and second parity bits in the second frame. The first parity bits and the second parity bits may be transmitted in a common time-slot of their respective frames. Time-slots may represent cycles of the clock signal relative to commencement or termination of respective frames. In one example, the first parity and the second parity bits are transmitted during the last of a plurality of clock cycles used to transmit the respective frames. In another example, the first parity bits and the second parity bits are transmitted during the first of the plurality of clock cycles used to transmit the respective frames.

The computer-readable storage medium 2118 may be a non-transitory storage medium and may code and/or one or more instructions that, when executed by one or more processors 2116, causes the processing circuit 2102 to configure a plurality of devices coupled to a bus such that, in a first mode of operation, the plurality of devices exchange data in a signal transmitted on a first lane of the bus in accordance with timing provided by a clock signal transmitted on a second lane of the bus, determine availability of one or more additional lanes connecting two or more devices in the plurality of devices, and configure the two or more devices to use the first lane and at least one of the additional lanes for data transmissions in a second mode of operation.

In one example, the one or more instructions further cause the processing circuit 2102 to transmit a command in the first mode of operation to define the second mode of operation as a double data rate mode of operation. The command may define a number of additional lanes used for data transmissions used in the second mode of operation.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. An apparatus, comprising:
a bus including a first lane and a second lane;
a plurality of devices coupled to the bus and, in a first mode of operation, configured to exchange data in a signal transmitted on the first lane in accordance with timing provided by a clock signal transmitted on the second lane; and
one or more additional lanes connecting two or more devices in the plurality of devices, the two or more devices being configured to use the first lane and at least one additional lane for data transmissions in a second mode of operation.

2. The apparatus of claim 1, wherein a command transmitted in the first mode of operation defines the second mode of operation as a double data rate mode of operation.

3. The apparatus of claim 2, wherein the command defines a number of additional lanes to be used for data transmissions in the second mode of operation.

4. The apparatus of claim 1, wherein data is encoded in symbols used to control signaling state of the first lane, the second lane and the one or more additional lanes in the second mode of operation, and a command transmitted in the first mode of operation defines a number of bits in the symbols.

5. The apparatus of claim 4 wherein, in the second mode of operation, information corresponding to timing of symbol transmissions is embedded in transitions between consecutively transmitted symbols.

6. The apparatus of claim 1, wherein a plurality of commands is transmitted on the bus, each command selecting a mode of operation for the bus, wherein the each command defines a number of additional lanes to be used for data transmissions in each selected mode of operation, and wherein the each command is transmitted in the first mode of operation.

7. The apparatus of claim 6, wherein each of the two or more devices is configured to support a number of data lanes.

8. The apparatus of claim 6, wherein the two or more devices are preconfigured by a master device to operate in both the first mode of operation and the second mode of operation.

9. The apparatus of claim 6, wherein in the second mode of operation a master device is adapted to:
ascertain a number of available lanes coupled to each of the two or more devices;
configure one or more slave devices to use at least some of the available lanes in the second mode of operation; and
dynamically adapt a protocol used in the second mode of operation to utilize a corresponding number of the available lanes when communicating with the one or more slave devices.

10. The apparatus of claim 6, wherein a protocol used in the second mode of operation is adapted to use a varying number of lanes to encode symbols for transmission.

11. The apparatus of claim 1, wherein data words are striped across lanes used to transmit data signals in the second mode of operation.

12. The apparatus of claim 1, wherein a first frame transmitted in the first mode of operation using only the first lane and the second lane and a second frame transmitted in the second mode of operation using the first lane, the second lane and the at least one additional lane have a common frame duration.

13. The apparatus of claim 12, wherein one or more parity bits transmitted in the first frame and a plurality of parity bits transmitted in the second frame are transmitted during a last of a plurality of clock cycles used to transmit the respective frames.

14. The apparatus of claim 12, wherein one or more parity bits transmitted in the first frame and a plurality of parity bits transmitted in the second frame are transmitted during a first of a plurality of clock cycles used to transmit the respective frames.

15. A method for data communication, comprising:
configuring a plurality of devices coupled to a bus such that, in a first mode of operation, the plurality of devices exchange data in a signal transmitted on a first lane of the bus in accordance with timing provided by a clock signal transmitted on a second lane of the bus;
determining availability of one or more additional lanes connecting two or more devices in the plurality of devices; and
configuring the two or more devices to use the first lane and at least one of the additional lanes for data transmissions in a second mode of operation.

16. The method of claim 15, further comprising:
transmitting a command in the first mode of operation to define the second mode of operation as a double data rate mode of operation.

17. The method of claim 16, wherein the command defines a number of additional lanes used for data transmissions in the second mode of operation.

18. The method of claim 15, wherein data is encoded in symbols used to control signaling state of the first lane, the second lane and the one or more additional lanes in the second mode of operation, and a command transmitted in the first mode of operation defines a number of bits in the symbols.

19. The method of claim 18, wherein, in the second mode of operation, information corresponding to timing of symbol transmissions is embedded in transitions between consecutively transmitted symbols.

20. The method of claim 15, further comprising:
transmitting a plurality of commands on the bus, each command selecting a mode of operation for the bus and a number of additional lanes used for data transmissions in each selected mode of operation, wherein the each command is transmitted in the first mode of operation.

21. The method of claim 20, further comprising:
transmitting one or more commands operative to configure each device in the two or more devices to support a number of data lanes.

22. The method of claim 20, further comprising:
ascertaining a number of available lanes coupled to each of the two or more devices;
configuring one or more slave devices to use at least some of the available lanes in the second mode of operation; and
dynamically adapting a protocol used in the second mode of operation to utilize a corresponding number of the available lanes when communicating with the one or more slave devices.

23. The method of claim 20, wherein a protocol used in the second mode of operation is adapted to use a varying number of lanes to encode symbols for transmission.

24. The method of claim 15, wherein data words are striped across lanes used to transmit data signals in the second mode of operation.

25. The method of claim 15, further comprising:
transmitting a first frame transmitted in the first mode of operation using only the first lane and the second lane; and
transmitting a second frame in the second mode of operation using the first lane, the second lane and the at least one of the additional lanes,
wherein the first frame and the second frame have a common frame duration.

26. The method of claim 25, further comprising:
transmitting first parity bits in the first frame; and
transmitting second parity bits in the second frame,
wherein the first parity bits and the second parity bits are transmitted during a last of a plurality of clock cycles used to transmit the respective frames.

27. The method of claim 25, further comprising:
transmitting first parity bits in the first frame; and
transmitting second parity bits in the second frame,
wherein the first parity bits and the second parity bits are transmitted during a first of a plurality of clock cycles used to transmit the respective frames.

28. A processor-readable storage medium having one or more instructions which, when executed by at least one processor of a processing circuit, cause the processing circuit to:
configure a plurality of devices coupled to a bus such that, in a first mode of operation, the plurality of devices exchange data in a signal transmitted on a first lane of the bus in accordance with timing provided by a clock signal transmitted on a second lane of the bus;
determine availability of one or more additional lanes connecting two or more devices in the plurality of devices; and
configure the two or more devices to use the first lane and at least one of the additional lanes for data transmissions in a second mode of operation.

29. The storage medium of claim 28, wherein the one or more instructions further cause the processing circuit to:
transmit a command in the first mode of operation to define the second mode of operation as a double data rate mode of operation,
wherein the command defines a number of additional lanes used for data transmissions in the second mode of operation.

30. A data communication apparatus comprising:
means for configuring a plurality of devices coupled to a bus such that, in a first mode of operation, the plurality of devices exchange data in a signal transmitted on a first lane of the bus in accordance with timing provided by a clock signal transmitted on a second lane of the bus;
means for determining availability of one or more additional lanes connecting two or more devices in the plurality of devices; and
means for configuring the two or more devices to use the first lane and at least one of the additional lanes for data transmissions in a second mode of operation.
